(19) United States
(12) Patent Application Publication
(10) Pub. No.: US 2020/0175496 A1
(43) Pub. Date: Jun. 4, 2020

(54) SYSTEMS AND METHODS FOR FACILITATING FUND TRANSFER

(71) Applicant: MSHIFT, INC., Newark, CA (US)

(72) Inventors: Alan FINKE, Pleasanton, CA (US); Xiaomeng ZHOU, Hayward, CA (US); John Eric BUCHBINDER, Orinda, CA (US); Scott MOELLER, Del Mar, CA (US); Robert OFFICER, Fremont, CA (US)

(21) Appl. No.: 16/671,507

(22) Filed: Nov. 1, 2019

Related U.S. Application Data
(63) Continuation of application No. PCT/US2018/032595, filed on May 14, 2018.
(60) Provisional application No. 62/505,370, filed on May 12, 2017.

(51) Int. Cl. G06Q 20/32; H04L 12/58; G06Q 20/10

(52) U.S. Cl. CPC G06Q 20/3276; G06Q 20/3224; G06Q 20/10; H04L 51/32; G06Q 20/3274

(57) ABSTRACT

Provided are systems and methods for facilitating fund transfer. The systems and methods described herein may facilitate fund transfer by (1) utilizing multiple clearing financial institutions (FIs), (2) utilizing multiple sequential clearing FIs for fund transfers between different countries, (3) utilizing push-only transfers, (4) utilizing graphical codes, such as quick response (QR) codes, and/or (5) utilizing social networking systems, to facilitate payment. The systems and methods may be implemented as an improved payment platform.

### CROSS-REFERENCE

This application is a continuation of International Patent Application No. PCT/US2018/32595, filed May 14, 2018, which claims the benefit of U.S. Provisional Patent Application No. 62/505,370, filed May 12, 2017, each of which applications is entirely incorporated herein by reference.

### BACKGROUND

Funds can be transferred between different accounts, such as between different accounts within a financial institution (e.g., bank), between accounts at different financial institutions, between different accounts of one individual or entity, between accounts of different individuals or entities, and/or between accounts in financial institutions in different countries (or otherwise sovereign territories). A fund transfer may be made for any reason, for example, as a gift between two acquaintances, as a bill payment, as a payment for a purchase, as a settlement of a debt or other unsettled accounts, and other reasons.

### SUMMARY

Transfers of funds can often involve non-insignificant costs, time delay, and security risk that can inconvenience both senders and recipients of the funds. Recognized herein is a need for systems and methods to facilitate efficient and expedited fund transfer in the existing banking infrastructure. The systems and methods described herein may facilitate fund transfer by (1) utilizing multiple clearing financial institutions (FIs), (2) utilizing multiple sequential clearing FIs for fund transfers between different countries, (3) utilizing push-only transfers, (4) utilizing graphical codes, such as quick response (QR) codes, and/or (5) utilizing social networking systems, to facilitate payment. The payment can be, for example, an external funds transfer, person-to-person (P2P) transfer, business-to-business (B2B) transfer, purchase at a point of sale (POS), international remittance, online banking payment, government payment or disbursement, mortgage or bill payment, direct deposit or other type of fund transfer or payment. The graphical code can be an identifier used to define a unique payment point, a recipient, and/or an invoice to facilitate payment. Embodiments of the systems and methods disclosed herein may implement any combination of the above methods. The systems and methods may be computer implemented. The systems and methods may be an improved payment platform. The systems and methods described herein may facilitate accounting of invoices. Various aspects of the systems and methods described herein may be applied to facilitate fund transfers or any other financial services application.

In an aspect, provided is a method for facilitating payment, comprising processing a fund transfer from an account of a sender to an account of a recipient, wherein a transfer path of the fund transfer begins at the account of the sender, ends at the account of the recipient, and includes at least one intermediary clearing account. In some embodiments, the transfer path may not include an intermediary clearing account, such as when the account of the sender and the account of the recipient are in the same financial institution.

In another aspect, provided is a method for facilitating payment, comprising: generating a graphical code encoding information about a payment in the graphical code; providing the graphical code by a recipient to a sender; entering or scanning the graphical code with a user device of the sender; providing the information about the payment on an electronic display of the user device; based on the information presented on the electronic display, providing authentication to approve the payment; and upon approval of the payment, processing a fund transfer from an account of the sender to an account of the recipient, wherein a transfer path of the fund transfer begins at the account of the sender, ends at the account of the recipient, and includes at least one intermediary clearing account. In some embodiments, the transfer path of the fund transfer can include at least one intermediary holding account. In some embodiments, the transfer path may not include an intermediary clearing account and/or an intermediary holding account, such as when the account of the sender and the account of the recipient are in the same financial institution.

In some embodiments, the recipient of the payment independently generates the graphical code. In some embodiments, the sender of the payment independently generates the graphical code. In some embodiments, a third party to the payment generates the graphical code.

In some embodiments, the graphical code is provided on a paper invoice. In some embodiments, the graphical code is provided on an electronic invoice.

In some embodiments, the account of the customer is located at a first financial institution located in a first sovereign state and the account of the merchant is located at a second financial institution located in a second sovereign state, and wherein the transfer path includes at least a transfer from a first intermediary clearing account at a first clearing financial institution located in the first sovereign state to a second intermediary clearing account at a second clearing financial institution located in the second sovereign state.

In some embodiments, the transfer path includes at least one intermediary holding account, wherein a given intermediary holding account is located at the same financial institution as the account of the customer or the account of the merchant.

In some embodiments, the intermediary clearing account is selected based at least on total transaction cost, available buffer funds at the intermediary clearing account, and total transfer time from the account of the customer to the account of the merchant.

In some embodiments, the graphical code is a two dimensional (2D) barcode, such as a QR code. In some embodiments, the graphical code is a one dimensional (1D) barcode, such as a UCC/EAN-128 code. In some embodiments, the graphical code is plain text, such as a printed series of numbers and letters.

In some embodiments, the method can further comprise detecting a point of sale location or a recipient's device using geo-location sensors in the user device. In some embodiments the method can further comprise detecting a point of sale location or recipient using radio beacon sensors, such as Bluetooth sensors (e.g., iBeacon®) in the user device.

In some embodiments, the transfer path includes a plurality of intermediary clearing accounts located at a plurality of intermediary clearing financial institutions.

In some embodiments, the sender or the recipient is a user of a social networking system. In some embodiments, the sender and the recipient are users of the social networking system, the method further comprising (i) messaging the receiver by the sender via the social networking system a notice of the payment, and (ii) accepting the notice by the receiver.

In some embodiments, the method further comprises remotely initiating the transfer via a web-based interface. In some embodiments, the method further comprises viewing the information about the payment, or modifying or administering the payment via the web-based interface. In some embodiments, the web-based interface is a remote online website.

In another aspect, provided is a system for facilitating payment, comprising: a communications interface in communication with a first electronic device of a first user and a second electronic device of a second user over a computer network; and one or more computer processors operatively coupled to the communications interface, wherein the one or more computer processors are individually or collectively programmed to: generate a graphical code encoding information about a payment in the graphical code; provide the graphical code to the first electronic device of the first user for presentation to the second user; upon scanning of the graphical code, providing the information about the payment to the second electronic device of the second user; and upon receiving approval of the payment from the second electronic device, processing a fund transfer from an account of the second user to an account of the first user, wherein a transfer path of the fund transfer begins at the account of the second user, ends at the account of the first user, and includes at least one intermediary clearing account.

In some embodiments, the graphical code is provided as part of an electronic invoice.

In some embodiments, the account of the first user is located at a first financial institution located in a first sovereign state and the account of the second user is located at a second financial institution located in a second sovereign state, and wherein the transfer path includes at least a transfer from a second intermediary clearing account at a second clearing financial institution located in the second sovereign state to a first intermediary clearing account at a first clearing financial institution located in the first sovereign state.

In some embodiments, the transfer path includes at least one intermediary holding account, wherein a given intermediary holding account is located at the same financial institution as the account of the first user or the account of the second user.

In some embodiments, the intermediary clearing account is selected based at least on total transaction cost, available buffer funds at the intermediary clearing account, and total transfer time from the account of the first user to the account of the second user.

In some embodiments, the graphical code is a QR code. In some embodiments, the graphical code is a UCC/EAN-128 code.

In some embodiments, the one or more computer processors are individually or collectively programmed to detect a point of sale location using geo-location sensors in the first electronic device or the second electronic device.

In some embodiments, the transfer path includes a plurality of intermediary clearing accounts located at a plurality of intermediary clearing financial institutions.

In some embodiments, the first user or the second user is a user of a social networking system. In some embodiments, the first user and the second user are users of the social networking system, and the communication interface facilitates sending a notice of the payment from the first electronic device to the second electronic device via the social networking system.

In some embodiments, the communications interface communicates with the first electronic device or the second electronic device via a web-based interface. In some embodiments, the one or more computer processors are individually or collectively programmed to display the information about the payment, or modify or administer the payment via the web-based interface. In some embodiments, the web-based interface is a remote online website.

In an aspect, provided is a method for facilitating payment, comprising: generating a graphical code encoding information about a payment in the graphical code; providing the graphical code by a sender to a recipient; entering or scanning the graphical code with a user device of the recipient; providing the information about the payment on an electronic display of a user device of the sender; based on the information presented on the electronic display, providing authentication to approve the payment; and upon approval of the payment, processing a fund transfer from an account of the sender to an account of the recipient, wherein a transfer path of the fund transfer begins at the account of the sender, ends at the account of the recipient, and includes at least one intermediary clearing account.

In some embodiments, the graphical code is provided on a paper. In some embodiments, the graphical code is provided electronically.

In some embodiments, the account of the customer is located at a first financial institution located in a first sovereign state and the account of the merchant is located at a second financial institution located in a second sovereign state, and wherein the transfer path includes at least a transfer from a first intermediary clearing account at a first clearing financial institution located in the first sovereign state to a second intermediary clearing account at a second clearing financial institution located in the second sovereign state.

In some embodiments, the transfer path includes at least one intermediary holding account, wherein a given intermediary holding account is located at the same financial institution as the account of the customer or the account of the merchant.

In some embodiments, the intermediary clearing account is selected based at least on total transaction cost, available buffer funds at the intermediary clearing account, and total transfer time from the account of the customer to the account of the merchant.

In some embodiments, the graphical code is a two dimensional (2D) barcode, such as a QR code. In some embodiments, the graphical code is a one dimensional (1D) barcode, such as a UCC/EAN-128 code. In some embodiments, the graphical code is plain text, such as a printed series of numbers and letters.

In some embodiments, the method can further comprise detecting a point of sale location or a recipient's device using geo-location sensors in the recipient user device or the sender user device.

In some embodiments, the transfer path includes a plurality of intermediary clearing accounts located at a plurality of intermediary clearing financial institutions.

In some embodiments, the sender or the recipient is a user of a social networking system. In some embodiments, the sender and the recipient are users of the social networking system, the method further comprising (i) messaging the receiver by the sender via the social networking system a notice of the payment, and (ii) accepting the notice by the receiver.

In some embodiments, the method further comprises remotely initiating the transfer via a web-based interface. In some embodiments, the method further comprises viewing the information about the payment, or modifying or administering the payment via the web-based interface. In some embodiments, the web-based interface is a remote online website.

In another aspect, provided is a system for facilitating payment, comprising: a communications interface in communication with a first electronic device of a first user and a second electronic device of a second user over a computer network; and one or more computer processors operatively coupled to the communications interface, wherein the one or more computer processors are individually or collectively programmed to: generate a graphical code encoding information about a payment in the graphical code; provide the graphical code to the second electronic device of the second user for presentation to the first user; upon scanning of the graphical code, providing the information about the payment to the second electronic device of the second user; and upon receiving approval of the payment from the second electronic device, processing a fund transfer from an account of the second user to an account of the first user, wherein a transfer path of the fund transfer begins at the account of the second user, ends at the account of the first user, and includes at least one intermediary clearing account.

In some embodiments, the graphical code is provided as part of an electronic invoice.

In some embodiments, the account of the first user is located at a first financial institution located in a first sovereign state and the account of the second user is located at a second financial institution located in a second sovereign state, and wherein the transfer path includes at least a transfer from a second intermediary clearing account at a second clearing financial institution located in the second sovereign state to a first intermediary clearing account at a first clearing financial institution located in the first sovereign state.

In some embodiments, the transfer path includes at least one intermediary holding account, wherein a given intermediary holding account is located at the same financial institution as the account of the first user or the account of the second user.

In some embodiments, the intermediary clearing account is selected based at least on total transaction cost, available buffer funds at the intermediary clearing account, and total transfer time from the account of the first user to the account of the second user.

In some embodiments, the graphical code is a QR code. In some embodiments, the graphical code is a UCC/EAN-128 code.

In some embodiments, the one or more computer processors are individually or collectively programmed to detect a point of sale location using geo-location sensors in the first electronic device or the second electronic device.

In some embodiments, the transfer path includes a plurality of intermediary clearing accounts located at a plurality of intermediary clearing financial institutions.

In some embodiments, the first user or the second user is a user of a social networking system. In some embodiments, the first user and the second user are users of the social networking system, and the communication interface facilitates sending a notice of the payment from the first electronic device to the second electronic device via the social networking system.

In some embodiments, the communications interface communicates with the first electronic device or the second electronic device via a web-based interface. In some embodiments, the one or more computer processors are individually or collectively programmed to display the information about the payment, or modify or administer the payment via the web-based interface. In some embodiments, the web-based interface is a remote online website.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein) of which:

FIG. 1 shows a schematic illustration of a fund transfer system communicating with multiple users.

FIG. 2A shows a schematic transfer flow from a consumer account to a merchant account with an intermediary clearing account and a corresponding timeline of the transfer flow.

FIG. 2B shows a schematic transfer flow from a consumer account to a merchant account with an intermediary clearing account and intermediary holding accounts and a corresponding timeline of the transfer flow.

FIG. 3 shows a schematic transfer flow with multiple intermediary clearing accounts at multiple intermediary clearing financial institutions.

FIG. 4 shows a schematic transfer flow with multiple sequential clearing financial institutions facilitating international remittance.

FIG. 5 shows a process flow for facilitating payment of a paper invoice using QR codes.

FIG. 6 shows computer control systems that are programmed to implement systems and methods of the disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Fund transfers can often involve significant costs and/or time delay, individually or in the aggregate, that can inconvenience both senders and recipients of the funds. Often these costs and/or time delay can vary with the type of transfer, such as within or between financial institutions. A financial institution (FI) can be a deposit-taking institution, such as a bank, building society, credit union, trust company, mortgage loan company, or other loan companies. A financial institution can be an insurance company, trust company, pension fund, broker, underwriter, investment fund, or other institutions or entities dealing with financial transactions. Any description herein of a bank may apply to any other type of financial institution. A financial institution can allow a user to have financial property, such as an account or a trust, with or entrusted to the financial institution. Such accounts or trusts can contain money, funds, or other tangible or intangible objects of positive (e.g., credit) or negative (e.g., debit, loans, etc.) financial value. An account can be a demand deposit account (DDA), checking account, savings account, line of credit account, loan account or other type of account. An accountholder at a bank can have a plurality of the same or different accounts at the bank. A plurality of accountholders can share a single account.

For example, funds can be transferred between different accounts within a same bank, between accounts at different banks, between different accounts of one individual or entity, between accounts of different individuals or entities, and/or between accounts in banks in different countries (or otherwise sovereign territories). In some instances, a transfer of funds between accounts within a same bank may be completed as an “on us” transaction, without cost or with lower cost to the sender and the recipient. Other types of transfers may incur various costs, such as by a bank of the sender, bank of the recipient, and/or intermediary system (e.g., clearing bank) facilitating the transfer. For example, for a credit card purchase, a discount rate and a transaction fee can be collected by the credit card company to process the fund transfer. Such discount rate and/or transaction fee can be a flat fee or a certain percentage of the amount of transfer (e.g., volume). Transaction fees can include fees such as authorization fees, return fees, gateway fees, AVS fees, currency exchange fees, and other fees charged to a transferor or transferee of funds. In another example, for an external fund transfer or interbanking fund transfer, there may be transactional fees associated with using an interbanking network such as the Automated Clearing House (ACH). Different types of transfers can be completed in different durations of time. For example, an “on us” transaction can be completed in a relatively shorter amount of time than other forms of transfer. An “on us” transfer can be instantaneous or substantially instantaneous. Instantaneous can include a response time of less than 10 seconds, 9 seconds, 8 seconds, 7 seconds, 6 seconds, 5 seconds, 4 seconds, 3 seconds, 2 seconds, 1 second, tenths of a second, hundredths of a second, a millisecond, or less. In some instances, an “on us” transfer can be completed in at most one business day.

The systems and methods described herein may facilitate fund transfer by (1) utilizing multiple clearing financial institutions (FIs), (2) utilizing multiple sequential clearing FIs for fund transfers between different countries, (3) utilizing push-only transfers, and/or (4) utilizing graphical codes, such as quick response (QR) codes, to facilitate payment. The payment can be, for example, an external funds transfer, person-to-person (P2P) transfer, business-to-business (B2B) transfer, purchase at a point of sale (POS), international remittance, online banking payment, government payment or disbursement, mortgage or bill payment, direct deposit or other type of fund transfer or payment. The systems and methods described herein may implement any combination of the above methods. The systems and methods may be computer implemented. The systems and methods may be an improved payment platform.

Reference is now made to the figures.

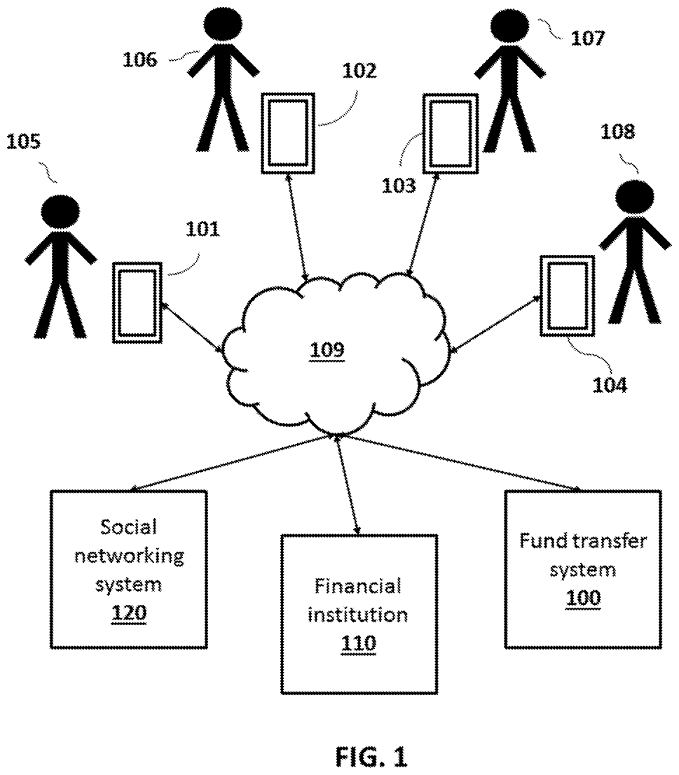

FIG. 1 shows a schematic illustration of a fund transfer system communicating with multiple users. A fund transfer system 100 may communicate with a plurality of users. For example, users 105, 106, 107, and 108 may communicate with the system 100 via user devices 101, 102, 103, and 104, respectively. A user (e.g., users 105, 106, 107, and 108) can be an individual or entity that is capable of engaging with the system 100. For example, a first user 105 may communicate with the system 100 via a first user device 101, a second user 106 may communicate via a second user device 102, a third user 107 may communicate via a third user device 103, and an nth user 108 may communicate with the system 100 via an nth user device 104. The system 100 may communicate simultaneously and/or independently with a plurality of users. In some instances, the system 100 may communicate with only a certain number of users (e.g., no more than 1, 2, 3, 4, 5, 6, 7, 8, 9, 10, 20, 30, 40, 50, 100, 150, 200, 250, 300, 400, 500, 1000, 10,000, 100,000, etc.) at certain times. Each of the users may communicate with the system 100 via a network 109.

A user can be a consumer, a merchant, a transferor, a transferee, a sender, a recipient, and/or any party to a fund transfer or other financial transaction. A user can be an individual or entity capable of legally owning financial property, such as an account, with financial institutions. A user can be an individual or entity capable of owning property, such as money. A user can be an individual or entity capable of depositing, withdrawing, entrusting, and/or storing, such property with financial institutions. For example, a user can be a legal entity (e.g., corporation, partnership, company, LLC, LLLC, etc.). A user can be a government or government entity. A user can be an individual or entity capable of initiating, sending, receiving, and/or approving a financial transfer or financial transaction.

The network 109 may be configured to provide communication between various components of the network layout depicted in FIG. 1. The network 109 may comprise one or more networks that connect devices and/or components in the network layout to allow communication between the devices and/or components. For example, the network may be implemented as the Internet, intranet, extranet, a wireless network, a wired network, a local area network (LAN), a Wide Area Network (WANs), Bluetooth, Near Field Communication (NFC), or any other type of network that provides communications between one or more components of the network layout. In some embodiments, the network 109 may be implemented using cell and/or pager networks, satellite, licensed radio, or a combination of licensed and unlicensed radio. The network may be wireless, wired (e.g., Ethernet), or a combination thereof. Systems and devices communicating the network 109 may communicate with the network via one or more network adaptors and/or communication interfaces. Additionally, while the network 109 is shown in FIG. 1 as a “central” point for communications between the various components (e.g., multi-person authentication and validation system 100, financial institution 110, user devices 101, 102, 103, and 104) of the network layout, the disclosed embodiments are not limited thereto. For example, one or more components of the network layout may be interconnected in a variety of ways, and may in some embodiments be directly connected to, co-located with, or remote from one another, as one of ordinary skill will appreciate. The network 109 can span across state or sovereign boundaries, such that the system 100 located in a first sovereign state can communicate with a user 105 located in a second sovereign state. A user 105 located in the second sovereign state can communicate with a user 106 located in a third sovereign state.

The user devices 101, 102, 103, and 104 may be an electronic device. For example, the user devices 101-104 may each be a mobile device (e.g., smartphone, tablet, pager, personal digital assistant (PDA)), a computer (e.g., laptop computer, desktop computer, server), and/or a wearable device (e.g., smartwatches). A user device can also include any other media content player, for example, a set-top box, a television set, a video game system, or any electronic device capable of providing or rendering data. For example, a user device can be a credit card processing machine or card reader. The user device may optionally be portable. The user device may be handheld. The user device may be a network device capable of connecting to a network, such as the network 109, or other networks such as a local area network (LAN), wide area network (WAN) such as the Internet, intranet, extranet, a telecommunications network, a data network, and/or any other type of network.

A user device may each comprise memory storage units which may comprise non-transitory computer readable medium comprising code, logic, or instructions for performing one or more steps. A user device may comprise one or more processors capable of executing one or more steps, for instance in accordance with the non-transitory computer readable media. The user device may comprise a display showing a graphical user interface (GUI). The user device may be capable of accepting inputs via a user interactive device. Examples of such user interactive devices may include a keyboard, button, mouse, touchscreen, touchpad, joystick, trackball, camera, microphone, motion sensor, heat sensor, inertial sensor, or any other type of user interactive device. For example, a user may input financial transaction commands or instructions to the system 100 via one or more user interactive devices. The user device may be capable of executing software or applications provided by one or more systems (e.g., social networking system 120, financial institution 110, fund transfer system 100, etc.). One or more applications may be related to fund transfer, payment processing, financial transactions. One or more applications and/or software can be related to a payment processing platform or fund transfer platform. One or more applications and/or software may be implemented in conjunction with a user interface on a GUI. For example, the user interface can be a mobile-based interface and/or a web-based interface.

A user device may comprise one or more sensors. For example, a user device may comprise one or more geo-location sensors that may be useful for detecting the location of the user device. For example, the geo-location sensors may use triangulation methods or global positioning systems (GPS) to aid in determining a location of the computing device. For example, one or more cell towers can use triangulation methods to locate a user device emitting or transmitting signals. A user device may comprise an image capture device or other optical sensor (e.g., camera) and be capable of capturing an image and/or reading an image (e.g., a code, text, etc.). For example, a camera can be integrated in the user device. The camera can be an external device to the user device and communicate via wired (e.g., cable) or wireless (e.g., Bluetooth, Wi-Fi, NFC, etc.) connection. The image capture device may be useful for capturing an image of the user or any other object within the user's environment. In some instances, the user device may receive or access one or more images captured by an external device in the external device memory, user device memory, and/or a separate storage space, including a database of a server or a cloud storage space. A user device may comprise a beacon (e.g., Bluetooth beacon) that is configured to broadcast an identifier or other data to nearby electronic devices. A user device may comprise an electronic display capable of displaying a graphical user interface.

The user device may be, for example, one or more computing devices configured to perform one or more operations consistent with the disclosed embodiments. In some instances, the software and/or applications may allow the users 105, 106, 107, and 108 to register with the fund transfer system 100, register with the financial institution 110, register with a social networking system 120, transmit and/or receive requests, commands, or instructions relating to financial transactions (e.g., fund transfer, payment processing, etc.), detect a location of the user device, broadcast an identifier or other data, transmit, receive, and/or process data, capture an image, read an image, such as read text via one or more optical character recognition (OCR) algorithms or read a code via one or more decrypting or decoding algorithms, and/or display an image.

The fund transfer system 100 may communicate with one or more users (e.g., users 105, 106, 107, and 108) via the network 109 to coordinate a plurality of transactions from, to, and/or between the one or more users and the system 100. In some instances, the system 100 may be configured to reliably identify an individual and authenticate the identified individual before accepting a user command or instruction (e.g., payment processing instruction, fund transfer instruction). To accomplish this, the system 100 may be programmed with (or otherwise store in memory instructions to implement) software and/or application to authenticate a user by requesting user credentials (e.g., PIN, passcode, password, username, etc.). In some instances, the system 100 may be equipped with hardware, for example, a biometric reader, for distinguishing the identity of the authorized user from an impostor. A system comprising a biometric reader may require an enrollment step, methods and hardware for acquiring the biometric data, and methods for comparing the biometric data that is acquired with the biometric data that the user enrolled with. A biometric reader used in this capacity may have thresholds for determining whether a biometric reading falls within the acceptable confidence range of the enrolled content. In some instances a biometric reader of this type may have built-in controls that prevent the biometric reader from being tampered with, should an impostor wish to use unintended means for accessing or authorizing sharing of the content. In some instances, the system 100 may communicate with an external device comprising the biometric reader. For example, user devices 101, 102, 103, and 104 can comprise biometric readers (e.g., sensors for fingerprints, retina, audio, facial recognition etc.) communicating with the system 100.

The system 100 and/or user devices of the users can individually or collectively comprise a biometric module for collecting, storing, processing, translating or analyzing biometric data. Biometric data may include any feature or output of an organism that can be measured and used to uniquely identify the organism. Biometric data may include, but are not be limited to, fingerprints, DNA, body temperature, facial features, hand features, retina features, ear features, and behavioral characteristics such as typing rhythm, gait, gestures and voice. The biometric module may receive data from biometric readers, for example, a fingerprint reader or retinal scanner, optical sensors, microprocessors, and RAM/ROM memory. Software components of the biometric module may comprise one or more software-based programs, including applications, protocols, or plugins, configured for collecting and/or processing biometric data from the hardware components of the biometric module. In some instances, collection and processing biometric data may comprise operations for analyzing the biometric data, creating a template (i.e. digital template) for biometric data, storing, matching, and verifying the biometric data (i.e. with an external database or previously stored information). In some embodiments a biometric reader may also be coupled to a user device through wired or wireless approaches. Wireless approaches may include one or more types of Wi-Fi or peer-to-peer (P2P) networking protocols. In other embodiments a biometric reader may be built into the web-enabled device. In some embodiments, the biometric module may be included, installed, or attached to the user device.

A fund transfer system 100 may comprise one or more screens, specialized displays, or graphical user interfaces (GUIs) for rendering information so that a user can identify and be presented with one or more content relating to a financial transaction (e.g., fund transfer, payment processing, etc.), such as on a payment processing platform. The system 100 may be further configured to process one or more images (e.g., QR codes, etc.) for display. The images that are processed may include images of payment instruments, such as checks. The system 100 may be communicatively coupled to another device (e.g., user devices 101, 102, 103, 104) comprising a screen, specialized display, and/or graphical user interface.

The system 100 may comprise one or more servers to perform some or all operations of the system 100, as described herein. A server, as the term is used herein, may refer generally to a multi-user computer that provides a service (e.g. validation, etc.) or resources (e.g. file space) over a network connection. The server may be provided or administered by an online service provider or administrator. In some cases, the server may be provided or administered by a third party entity in connection with a device provider. Any description of a server herein can apply to multiple servers or other infrastructures. For example, one or more servers can collectively or individually perform the operations of the system 100 disclosed herein. In some instances, the server may include a web server, an enterprise server, a database server, or any other type of computer server, and can be computer-programmed to accept requests (e.g., HTTP, or other protocols that can initiate data transmission) from a computing device (e.g., a user device, a public share device) and to serve the computing device with requested data. In addition, the server can be a broadcasting facility, such as free-to-air, cable, satellite, and other broadcasting facility, for distributing data. The server may also be a server in a data network (e.g., a cloud computing network, peer-to-peer configuration, etc.).

In some embodiments, the online service provider of the system 100 may administer one or more servers to provide various services to users of the system. While some disclosed embodiments may be implemented on the server, the disclosed embodiments are not so limited. For instance, in some embodiments, other devices (such as one or more user devices of the users) or systems (such as one or more financial institutions) may be configured to perform one or more of the processes and functionalities consistent with the disclosed embodiments, including embodiments described with respect to the server and the multi-person authentication and validation system.

A user (e.g., user 105, 106, 107, or 108) may be registered to the system 100, such as via creating an online account with a server of the system 100. Upon registration, the user may provide the system 100 with information that enables a system to process a transaction to or from the user. For example, the user may provide personal financial information, such as name of a financial institution, account number, and routing information. In some instances, only registered users may be provided with one or more services of the fund transfer system 100. In other instances, any user, registered or not, may be provided with one or more services of the fund transfer system 100. For example, a registered user can be capable of receiving funds. The system 100 may directly deposit funds received from a sender into the registered user's account using information provided by the registered user. The registered user may be provided with other services or options upon receipt of a fund transfer, such as the ability to re-transfer, gift, or split tender. An unregistered user can be capable of receiving funds. For example, upon receipt of the fund transfer, the system 100 can prompt the unregistered user to register with the system 100 to open up other capabilities provided to registered users (e.g., re-transfer, gift, split tender, direct deposit to FI account, etc.). An unregistered user may be tendered the received funds, such as through an identifier (e.g., barcode, graphical code, code, PIN, etc.) which can be provided by the unregistered user to an automated teller machine (ATM) of a FI or a register user (e.g., sender, third party) of the system 100. A registered user may be able to transfer funds to a registered recipient or an unregistered recipient. For example, the system 100 may use information provided by the registered user (e.g., account information, etc.) to initiate the transfer. Such transfers facilitated by the system 100 can be “push” type transfers. “Push” and “pull” transfers are described further below.

Beneficially, since the system 100 can act as an intermediary in all transactions, the recipient never receives sensitive information, such as a credit card number or FI account number, from or associated with the sender that can be used or reused for fraudulent or other malicious purposes, thus reducing fraud that may occur in other payment systems. For example, recipients of payments, goods, services, P2P transfers, B2B transfers, and other transfers do not receive sensitive and/or personal information from their respective senders. Similarly, and beneficially, the sender never receives sensitive information from or associated with the recipient thus enhancing the security of the invention. Such sensitive and/or personal information is shared with the system 100, and within the system network, thus protecting against potential leak of, or compromise to, the data outside the unsecure system network. Sender FIs or recipient FIs may retain information of the other, such as for compliance with regulations, but protect such information from the accountholders.

In some instances, the fund transfer system 100 can be used in conjunction with a financial institution 110, and/or one or more systems operated thereby. The financial institution 110 can communicate with the fund transfer system 100 via the network 109. The financial institution 110 can communicate with one or more user devices (e.g., user devices 101, 102, 103, and 104) via the network 109 or another network. In some instances, a user (e.g., user 105, 106, 107, or 108) may be registered to or enrolled with the financial institution 110. For example, a user may or may not have an account with the financial institution 110. In some instances, a user may be registered to both the fund transfer system 100 and the financial institution 110. In such cases, the user may authorize the fund transfer system 100 and the financial institution 110 to share user information (e.g., user account information, user account history, user transaction information, personal financial information such as account number and routing number, etc.). While only one financial institution 110 is shown in FIG. 1, there may be multiple different financial institutions 110 communicating with the network 109.

In some instances, the fund transfer system 100 can be used in conjunction with a social networking system 120, and/or one or more systems operated thereby. The social networking system 120 can communicate with the fund transfer system 100 via the network 109. The social networking system 120 can communicate with one or more user devices (e.g., user devices 101, 102, 103, and 104) via the network 109 or another network. In some instances, a user (e.g., user 105, 106, 107, or 108) may be registered to or enrolled with the social networking system 120. For example, a user may or may not have an account with the social networking system 120. In some instances, a user may be registered to both the fund transfer system 100 and the social networking system 120. In such cases, the user may authorize the fund transfer system 100 and the social networking system 120 to share user information (e.g., user account information, user account history, user transaction information, personal financial information such as account number and routing number, social networking contact list, etc.). While only one social networking system 120 is shown in FIG. 1, there may be multiple different social networking systems communicating with the network 109.

A social network can be a social structure comprising at least one set of social entities (such as, e.g., individuals or organizations). The social network may have a set of dyadic ties or connections (or links) between these entities. Such ties or connections may be complex (e.g., first degree connections, second degree connections, third degree connections, one-to-one relationships, one-to-many relationships, many-to-one relationships, etc.). A social network can include various networks in which a user interacts with other users, such as a social group network, education network, and/or work network. A social network of a user can be characterized by, for example, a contacts list (e.g., address book, email contacts list) or a social media network (e.g., Facebook® friends list, Google+® friends list, LinkedIn® contacts, Twitter® Following list, Line® friends, etc.) of the user. For example, a social network of a user can be a contacts list for a messaging (e.g., chatting, instant messaging, etc.) service. The social networking system 120 may comprise one or more processors and a memory communicatively coupled to the one or more processors to characterize one or more social networks between users. For example, for each user of the social networking system, the social networking system may store the user's contacts list and the user's social media network. A user that is a member of a social networking system may have a unique profile with the social networking system. The social networking system may further store and/or track the user's activities on the social networking system.

The social networking system 120 may host on its server, or via an independent server, various services for its users, such as communication services (e.g., email, instant messaging, chat, comments, messages, voice calls, video calls, etc.), sharing services (e.g., file sharing, document sharing, photo sharing, image sharing, video sharing, etc.), social network feed services, locational services, live (e.g., real-time) video services, and/or other services. In some instances, the social networking system may be capable of implementing the systems and methods described herein, such as via an API deployed by the fund transfer system 100 and/or the financial institution 110, to enable services offered by the fund transfer system 100 and/or the financial institution 110.

For example, a user device may be capable of executing software and/or applications provided by the social networking system 120. The software and/or applications can integrate fund transfer capabilities of the fund transfer system 100 and/or the financial institution 110. In some instances, a network of the social networking system 120 can be linked to or otherwise electronically connected to a network of the fund transfer system 100 and/or a network of the financial institution 110. In some instances, a user that is registered to both the fund transfer system 100 and the social networking system 120 may link together, or otherwise electronically connect, the user's social networking account with the social networking system 120 and one or more FI accounts (e.g., demand deposit account, checking account, bank account, etc.) with or linked to the fund transfer system 100. The user may, from a social networking platform, use such linked accounts to initiate a fund transfer, such as to send a person to person (P2P) transfer to a social networking contact, purchase real goods or services, purchase virtual goods or services (e.g., stickers, subscriptions, etc.), purchase goods or services on behalf of another user (e.g., gift coupons, etc.), or complete other financial transactions.

A user of the social networking system 120 may also receive P2P transfers, receive real goods or services, and/or receive virtual goods or services sent by another user of the social networking system 120 via the software and/or applications provided by the social networking system 120. If a recipient user has linked one or more FI accounts to the recipient user's social networking account, the recipient user may further deposit such received funds into the recipient user's FI account, in whole or in part. In some instances, the depositing can be an automatic process. In some instances, the depositing can occur after the recipient user authorizes deposit. In some instances, the recipient user may be initially notified of an intent to transfer from a sender user (e.g., by a notice), such as through a messaging service of the social networking system 120, and the transfer can be initiated only after the recipient user accepts. If the recipient user rejects the transfer, the sender recipient can be notified of the rejection and the transfer can be halted (before initiation). If a recipient user has linked one or more FI accounts to the recipient user's social networking account, the recipient user may accept, re-send, and/or re-gift the received funds, goods, and services, in whole or in part. In some instances, if a recipient user has not linked a FI account to the recipient user's social networking account, the recipient user may not have an option to re-gift and/or re-send the received funds, goods, and services, for example, because a one way push automated clearing house (ACH) transaction for the re-sending may not be completed without information of the originating (e.g., source) FI account. If a recipient user has not linked a FI account to the recipient user's social networking account, the recipient user may be prompted to register with, enroll in, or link one or more FI accounts to use in conjunction with the social networking system 120. In some instances, a social networking account identifier (e.g., social network ID) of a user can be used to identify as the user identifier of the fund transfer system 100 and/or of the financial institution 110.

In some instances, the fund transfer system 100 can be used in conjunction with both the financial institution 110 and the social networking system 120. The fund transfer system 100 can be used independently. Alternatively or in addition, the fund transfer system 100 can be used in conjunction with any other systems and/or servers (e.g., hosting a site, website, forum, blog, etc.) through which a user can initiate or become party to a financial transaction. The fund transfer system 100 can be used with a plurality of other systems and/or servers. For example, the fund transfer system 100 can communicate with one or more financial network systems (e.g., automated clearing house (ACH) network, SWIFT network, etc.). In another example, the fund transfer system 100 can communicate with or be integrated in an independent system (e.g., web-based interface) hosted by a merchant. The transfers described herein can be implemented and/or initiated, individually or collectively, by the one or more systems described herein. For example, an application and/or software deployed or administered by one system (e.g., fund transfer system 100, financial institution 110, social networking system 120) can be integrated or incorporated into an application and/or software deployed or administered by another system and/or into hardware devices (e.g., user devices). The application and/or software can be deployed or administered by an intermediary entity (e.g., not the financial institution 110, not the social networking system 120, not a party to the transfer such as the merchant or the customer, etc.). Alternatively or in addition, an application and/or software can be provided as a standalone application. Alternatively or in addition, an application and/or software can be integrated or incorporated into other applications or hardware devices.

The systems and methods described herein may facilitate a fund transfer. By way of example, a consumer can process a payment to a merchant, such as for a purchase of goods or services, via initiating a fund transfer from a consumer account at a consumer FI to a merchant account at a merchant FI. Alternatively or in addition, the fund transfer can be between any two accountholders. The fund transfer can be an external funds transfer, person-to-person (P2P) transfer, business-to-business (B2B) transfer, online banking payment, government payment or disbursement, mortgage or bill payment, direct deposit or other type of fund transfer or payment. To complete a fund transfer (e.g., for funds to leave a source account and arrive at a recipient account), funds may undergo a clearing process. During clearing of a transfer, one or more FIs may perform operations such as regulating, monitoring, reporting, settling, handling taxes and costs, managing failures or errors, and/or determining margins.

The systems and methods described herein can seek the lowest cost interbanking or intrabanking transaction (e.g., transfer) path for settlement and/or clearing. In some instances, the FI of the consumer and the merchant FI may be the same FI and the lowest cost transfer path may be via an “on us” transfer. Such transfers within the same FI may be completed without significant cost or time delay. For example, such “on us” transfers may be completed at relatively little or no cost. “On us” transfers may be completed instantaneously or substantially instantaneously. “On us” transfers may be completed in relatively shorter durations of time (e.g., within a business day, 2 business days, etc.). Alternatively or in addition, the lowest cost transfer path may pass through one or more interbanking networks. For example, the interbanking network can be the Automated Clearing House (ACH) network or the Electronic Payment Network (EPN) in the United States, Zengin-Net network in Japan, CECOBAN in Mexico, PostFinance in Switzerland, ACSS in Canada, or other networks. The interbanking network may be international banking networks (e.g., SWIFT, Fedwire, etc.). Any description herein of ACH or a clearing house (e.g., bank) may apply to any other type of interbanking network, entity, or system within the U.S., in another country, or across a plurality of countries. In other instances, the consumer FI and the merchant FI may be different FIs, and the transfer may pass through the ACH network. Alternatively or in addition, fund transfers may be performed via wire transfers, which can be costly but with shorter processing and/or clearing periods.

A transfer passing through one or more interbanking networks (e.g., ACH, Zengin-Net, SWIFT, etc.) may incur a transactional cost or fee which is forwarded to the sender, the recipient, and/or the FI of either. The transactional cost or fee can be on a per transfer basis, per amount basis, per client basis, or other bases. Furthermore, a transfer passing through one or more interbanking networks may be delayed on the order of days (e.g., at least 1 business day, 2 business days, 3 business days, 4 business days, 5 business days, 6 business days, 7 business days, or longer), such as to comply with regulations, ensure clearing, and/or protect against fraudulent transfers. Different FIs may charge different fees (e.g., by taking the cost of the transfer), and/or offer different delivery (e.g., transfer, clearing, etc.) time.

One or more intermediary clearing accounts and/or intermediary holding accounts may facilitate fund transfers, such as by mitigating transfer cost and time.

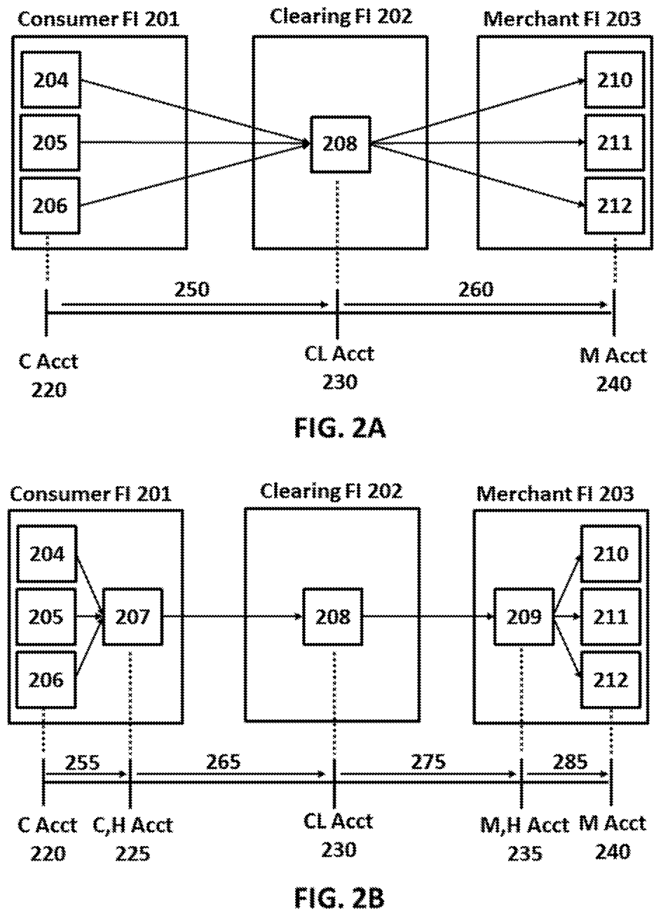

FIG. 2A shows a schematic transfer flow from a consumer account to a merchant account with an intermediary clearing account and a corresponding timeline of the transfer flow.

One or more consumers may be accountholders at a consumer FI 201, and one or more merchants may be accountholders at a merchant FI 203. Funds may be transferred from a consumer account (e.g., one of consumer accounts 204, 205, 206) to a merchant account (e.g., one of merchant accounts 210, 211, 212), such as by passing through an intermediary clearing account 208 at a clearing FI 202. An account can be a checking account, savings account, line of credit, deposit account, general ledger (GL) account, or other type of account. The consumer FI 201, clearing FI 202, and merchant FI 203 may each be the same FI, different FIs, or two of the FIs can be the same FI and the third a different FI. In some instances, the funds may be transferred directly from a consumer account to a merchant account without passing through a clearing account.

A transfer can be initiated by the consumer, such as by submitting a request to ‘push’ funds to a merchant, from a customer account 204 to a merchant account 210. Alternatively, a transfer can be initiated by the merchant, such as by submitting a request to ‘pull’ funds (e.g., automatic bill payment, etc.) from a consumer. Such requests, commands, and/or instructions can be made electronically and/or online. Upon initiation of the transfer, the fund transfer system (e.g., system 100 in FIG. 1) can first initiate a transfer from a consumer account 204 to an intermediary clearing account 208. An ACH process may be used. Alternatively, an “on us” transfer may be completed between the consumer account and the intermediary clearing account, for example, if the consumer FI 201 and the clearing FI 202 are the same FI.

The intermediary clearing account 208 can belong to an intermediary. The intermediary can be a third party to the transfer that is neither the consumer (e.g., sender) nor the merchant (e.g., intended recipient). For example, the intermediary may be an operator, administrator, and/or online service provider of the fund transfer system. The intermediary can be a party to the transfer. The intermediary can be a correspondent bank. An intermediary clearing account may provide increased security between consumer accounts and merchant accounts which do not have to release sensitive financial information (e.g., account information, etc.) to the other to complete the transfer. In some instances, the intermediary may provide convenient payment processing or financial transaction platforms or hubs (e.g., user friendly GUI, etc.) to facilitate fund transfer between two users. The intermediary may provide convenient services that a transferor (e.g., consumer) or transferee (e.g., merchant) uses to initiate the transfer.

The fund transfer system can then initiate a transfer from the intermediary clearing account 208 to the merchant account 210. An ACH process may be used. Alternatively, an “on us” transfer may be completed between the consumer account and the intermediary clearing account, for example, if the clearing FI 202 and the merchant FI 203 are the same FI. An ACH process may require at least one business day, two business days, three business days, four business days, five business days, or longer to complete. In some instances, a FI may offer faster delivery for additional cost.

Similarly, upon request for other transfers from accounts at the consumer FI 201 to accounts at the merchant FI 203, such as requests to transfer from consumer accounts 204, 205, and/or 206 to merchant accounts 210, 211, and/or 212, the fund transfer system can direct the transfers through the intermediary clearing account 208 at the clearing FI 202. Beneficially, the intermediary clearing account can aggregate and accumulate buffer funds as different funds at different points in time pass through the intermediary clearing account. When there are sufficient buffer funds available in the intermediary clearing account, upon initiation of the transfer by the consumer, the fund transfer system may initiate transfers between (i) the consumer account and the intermediary clearing account, and (ii) the intermediary clearing account and the merchant account, substantially simultaneously or with relatively short time lapse (e.g., less than one business day).

A timeline is illustrated. A transfer between a consumer FI and merchant FI may be a two part transfer, wherein a first transfer 250 is made from a customer account 220 to an intermediary clearing account 230 and a second transfer 260 is made from the intermediary clearing account 230 to a merchant account 240. In some instances, the second transfer 260 may be initiated upon completion of the first transfer 250. Such transfers can take the length of two separate inter-banking transfers. In other instances, the first transfer 250 and the second transfer 260 may be initiated substantially simultaneously or with relatively short time lapse. Beneficially, such transfers can take the length of only one interbanking transfer because they are carried out substantially simultaneously.

While FIG. 2A shows exemplary fund transfer paths, the fund transfer paths are not limited as such. In some instances, a transfer path can include any number of intermediary clearing accounts, wherein the funds pass through sequentially or selectively. Such intermediary clearing accounts may be managed or owned by the same or different intermediaries. While FIG. 2A illustrates transfers between a consumer and a merchant, the parties are not limited as such. The descriptions herein can apply to a transfer between any transferor (e.g., consumer, sender, payer, etc.) and any transferee (e.g., merchant, recipient, payee, etc.).). For example, the transfer can be any type of transfer described elsewhere herein (e.g., external funds transfer, person-to-person (P2P) transfer, business-to-business (B2B) transfer, online banking payment, government payment or disbursement, mortgage or bill payment, direct deposit, etc.).

FIG. 2B shows a schematic transfer flow from a consumer account to a merchant account with an intermediary clearing account and intermediary holding accounts and a corresponding timeline of the transfer flow.

One or more consumers may be accountholders at a consumer FI 201, and one or more merchants may be accountholders at a merchant FI 203. Funds may be transferred from a consumer account (e.g., one of consumer accounts 204, 205, 206) to a merchant account (e.g., one of merchant accounts 210, 211, 212), such as by passing through an intermediary customer FI holding account 207, intermediary clearing account 208 at a clearing FI 202, and intermediary merchant FI holding account 209. The consumer FI 201, clearing FI 202, and merchant FI 203 may each be the same FI, different FIs, or two of the FIs can be the same FI and the third a different FI. In some instances, the funds may be transferred directly from a consumer account to a merchant account without passing through an intermediary clearing account and/or without passing through one or more intermediary holding accounts.

A transfer can be initiated by the consumer, such as by submitting a request to ‘push’ funds to a merchant, from a customer account 204 to a merchant account 210. Alternatively, a transfer can be initiated by the merchant, such as by submitting a request to ‘pull’ funds (e.g., automatic bill payment, etc.) from a consumer. Such requests, commands, and/or instructions can be made electronically and/or online. Upon initiation of the transfer, the fund transfer system (e.g., system 100 in FIG. 1) can first initiate a transfer from a consumer account 204 to an intermediary customer FI holding account 207. The customer account and the intermediary customer FI holding account can both be at the same customer FI 201. An “on us” transfer may be completed between the consumer account and the intermediary customer FI holding account. Such “on us” transfers may incur relatively little or no cost and be completed in relatively less time than other transfer processes.

An intermediary holding account (e.g., intermediary customer FI holding account 207, intermediary merchant FI holding account 209, etc.) can belong to an intermediary. The same intermediary can own both the intermediary holding account and the intermediary clearing account 208. In some instances, the intermediary can own an intermediary holding account at each FI, for example, for which there is a transfer to or from a given FI. In some instances, the intermediary can be a financial institution. The intermediary can own a plurality of intermediary holding accounts at each FI. An intermediary holding account may provide increased security for the transfer, such as to prevent fraud, and hold necessary funds set aside for transfer for clearing. Beneficially, at a time of purchase, funds transferred substantially instantaneously from a consumer account to an intermediary holding account can guarantee the funds for the merchant. FIs for which the intermediary has an intermediary holding account can be referred to as an “in-network” FI and FIs for which the intermediary does not have an intermediary holding account can be referred to as an “out of network” FI.

The fund transfer system can then initiate a transfer from the intermediary consumer FI holding account 207 to an intermediary clearing account 208. An ACH process may be used. Alternatively, an “on us” transfer may be completed, for example, if the consumer FI 201 and the clearing FI 202 are the same FI. The fund transfer system can then initiate a transfer from the intermediary clearing account 208 to an intermediary merchant FI holding account 209. An ACH process may be used. Alternatively, an “on us” transfer may be completed, for example, if the clearing FI 202 and the merchant FI 203 are the same FI. The fund transfer system can then initiate a transfer from the intermediary merchant FI holding account 209 to the merchant account 210. An “on us” transfer may be completed between the intermediary merchant FI holding account and the merchant account. Such “on us” transfers may incur relatively little or no cost and be completed in relatively less time. “On us” transfers can be instantaneous or substantially instantaneous.

Similarly, upon request for other transfers from accounts at the consumer FI 201 to accounts at the merchant FI 203, such as requests to transfer from consumer accounts 204, 205, and/or 206 to merchant accounts 210, 211, and/or 212, the fund transfer system can direct the transfers first through the intermediary consumer FI holding account 207, then to the intermediary clearing account 208 at the clearing FI 202, and then to the intermediary merchant FI holding account 209. Beneficially, an intermediary holding account can aggregate and accumulate funds for an accumulated transfer to and from the intermediary clearing account 208. This may significantly reduce overall transfer costs, such as where interbanking transfer costs are incurred on a per transaction or per client basis.

Beneficially, the intermediary clearing account 208 can aggregate and accumulate buffer funds as different funds at different points in time pass through the intermediary clearing account. When there are sufficient buffer funds available in the intermediary clearing account, upon initiation of the transfer by the consumer, the fund transfer system may initiate transfers between (i) the intermediary consumer FI holding account and the intermediary clearing account, and (ii) the intermediary merchant FI holding account and the intermediary clearing account, substantially simultaneously or with relatively short time lapse (e.g., less than one business day). Additionally, the fund transfer system may initiate transfers between (i) the consumer account and the intermediary consumer FI holding account, and/or (ii) the intermediary merchant FI holding account and the merchant account, substantially simultaneously or with relatively short time lapses with the other transfers.

A timeline is illustrated. A transfer between a consumer FI and merchant FI may be a four part transfer, wherein a first transfer 255 is made from a customer account 220 to an intermediary customer FI holding account 225, a second transfer 265 is made from the intermediary customer FI holding account 225 to an intermediary clearing account 230, a third transfer 275 is made from the intermediary clearing account 230 to an intermediary merchant FI holding account 235, and a fourth transfer 285 is made from the intermediary merchant FI holding account 235 to a merchant account 240. In some instances, each transfer may be initiated upon completion of the previous transfer (e.g., second transfer 265 after first transfer 255, third transfer 275 after second transfer 265, fourth transfer 285 after third transfer 275). Such transfers can take the length of four separate transfers, which length may vary with whether each transfer is an interbanking transfer or an intrabanking (e.g., “on us”) transfer. In other instances, one or more transfers may be initiated substantially simultaneously or with relatively short time lapse. For example, all four transfers may be initiated substantially simultaneously. In another example, the second transfer 265 and the third transfer 275 may be initiated simultaneously, but only after the completion of the first transfer 255. In another example, the fourth transfer 285 may be initiated only after completion of the second transfer 265 and the third transfer 275, which may or may not be completed simultaneously. Beneficially, such transfers can reduce total transfer time. Thus, both transfer cost and time can be reduced.

Buffer funds can be provided in intermediary accounts (e.g., intermediary holding accounts, intermediary clearing accounts, etc.) to facilitate simultaneous transfers. In some instances, an intermediary account can be linked to, or implemented as, loan accounts from the financial institution in which the intermediary account is located. Beneficially, when insufficient buffer funds are available in the intermediary account, an overdraw of funds from the intermediary account can be immediately and automatically substituted with loans (e.g., short-term loans, long-term loans) from the financial institution such that the transfer can proceed without delay. The loans can be paid back as soon as other funds are propagated through the transfer chain. Such transfers may or may not incur interest on such loans.

While FIG. 2B shows exemplary fund transfer paths, the fund transfer paths are not limited as such. In some instances, a transfer path can include any number of intermediary clearing accounts, wherein the funds pass through sequentially or selectively. In some instances, a transfer path can include any number of intermediary holding accounts, wherein the funds pass through sequentially or selectively. Such intermediary clearing accounts and/or holding accounts may be managed or owned by the same or different intermediaries. While FIG. 2B illustrates transfers between a consumer and a merchant, the parties are not limited as such. The descriptions herein can apply to a transfer between any transferor (e.g., consumer, sender, payer, etc.) and any transferee (e.g., merchant, recipient, payee, etc.).). For example, the transfer can be any type of transfer described elsewhere herein (e.g., external funds transfer, person-to-person (P2P) transfer, business-to-business (B2B) transfer, online banking payment, government payment or disbursement, mortgage or bill payment, direct deposit, etc.).

In some instances, the transfers in the systems and methods described herein, such as above or further below, may only be initiated by the sender, transferor, and/or owner of the source account (e.g., originating account). For example, transfers may only be initiated as ‘push’ transfers. The system and methods may disallow ‘pull’ transfers that can be initiated by the recipient, transferee, and/or owner of the receiving account. Pull transfers can be debit transfers from a source account. Examples of pull transfers include, but are not limited to, automated billing payments, automated utility payments, and/or subscription payments. Pull transfers can be initiated by a receiving account. Push transfers can be credit transfers to a receiving account. Examples of push transfers include, but are not limited to, payroll direct deposits, cash, checks, government payments, wire transfers, and/or invoice payments. Push transfers can be initiated by a source account. Beneficially, a push transfer cannot be processed unless there are sufficient funds in the source account, unlike pull transfers, which can process the transfer and as a result render a negative balance in the source account. Furthermore, holding time of funds can be reduced for push transfers because transfers can be pre-verified by the sending bank (e.g., FI), unlike pull transfers, where transfers can be verified with the sending bank to prolong holding time. In some embodiments, each transfer facilitated by the systems and methods described herein may be a push transfer. In some instances, push transfers can depend on the ACH process and/or regulations imposed by one or more jurisdictions in which the transfers occur.

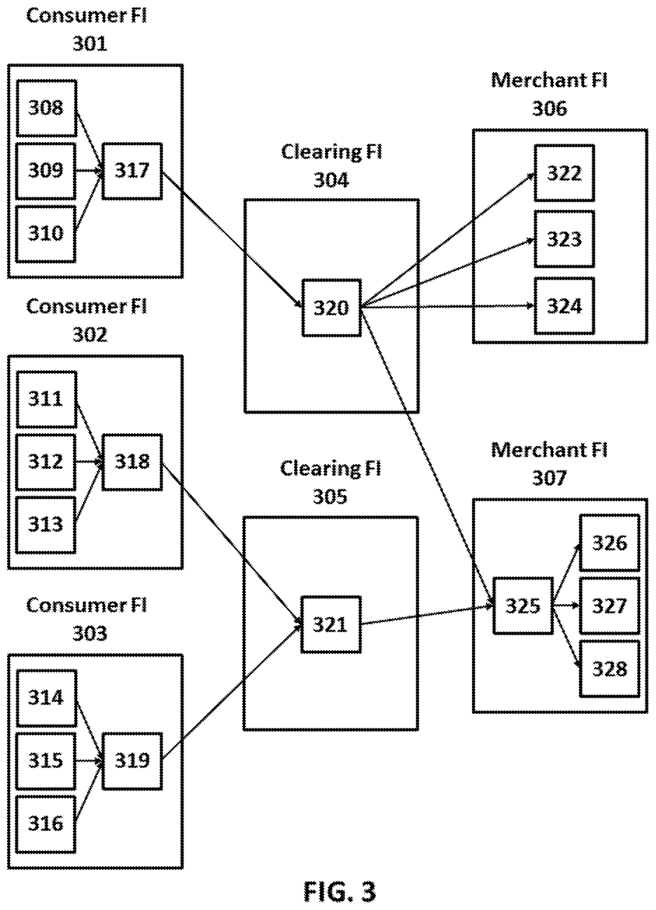

FIG. 3 shows a schematic transfer flow with multiple intermediary clearing accounts at multiple intermediary clearing financial institutions.

One or more consumers may be accountholders at a consumer FI (e.g., 301, 302, and 303), and one or more merchants may be accountholders at a merchant FI (e.g., 306, 307). Funds may be transferred from a consumer account (e.g., one of consumer accounts 308-316) to a merchant account (e.g., one of merchant accounts 322-324, 326-328), such as by passing through an intermediary customer FI holding account (e.g., one of 317-319), then through one or more intermediary clearing accounts 320, 321 at a clearing FI (e.g., 304, 305), and then through an intermediary merchant FI holding account 325. The one or more consumer FIs, one or more clearing FIs, and one or more merchant FIs may each be the same FI or different FIs, or some FIs may be the same FI and other FIs may be different FIs. In some instances, the funds may be transferred directly from a consumer account to a merchant account without passing through one or more intermediary clearing account and/or without passing through one or more intermediary holding accounts.

A transfer can be initiated by the consumer, such as by submitting a request to ‘push’ funds to a merchant, such as from a customer account 308 to a merchant account 326. Alternatively, a transfer can be initiated by the merchant, such as by submitting a request to ‘pull’ funds (e.g., automatic bill payment, etc.) from a consumer. Such requests, commands, and/or instructions can be made electronically and/or online. Both the customer FI 301 to which the customer account 308 belongs and the merchant FI 307 to which the merchant account 326 belongs can be “in-network” FIs (e.g., for which an intermediary has an intermediary holding account).

Upon initiation of the transfer, the fund transfer system (e.g., system 100 in FIG. 1) can first initiate a transfer from the consumer account 308 to an intermediary customer FI holding account 317. The customer account and the intermediary customer FI holding account can both be at the same customer FI 301. An “on us” transfer may be completed between the consumer account and the intermediary customer FI holding account. Such “on us” transfers may incur relatively little or no cost and be completed in relatively less time. Such “on us” transfers may be completed instantaneously or substantially instantaneously.

The fund transfer system can then initiate a transfer from the intermediary consumer FI holding account 317 to an intermediary clearing account. There can be a first intermediary clearing account 320 at a first clearing FI 304 and a second intermediary clearing account 321 at a second clearing FI 305 from which funds can be transferred to the merchant FI 307. The fund transfer system may select to transfer the funds to the first clearing FI 304 based on one or more factors (e.g., buffer funds available, time delay, costs, etc.) that are described further below. For example, based on these factors, the fund transfer system can initiate a transfer from the intermediary consumer FI holding account 317 to the first intermediary clearing account 320. An ACH process may be used for this transfer. Alternatively, an “on us” transfer may be completed, for example, if the consumer FI 301 and the first clearing FI 304 are the same FI.

The fund transfer system can then initiate a transfer from the first intermediary clearing account 320 to an intermediary merchant FI holding account 325. An ACH process may be used. Alternatively, an “on us” transfer may be completed, for example, if the first clearing FI 304 and the merchant FI 307 are the same FI. The fund transfer system can then initiate a transfer from the intermediary merchant FI holding account 325 to the merchant account 326. An “on us” transfer may be completed between the intermediary merchant FI holding account and the merchant account. Such “on us” transfers may incur relatively little or no cost and be completed in relatively less time.

Similarly, upon request for other transfers from accounts at a transferor FI (e.g., 301, 302, 303) to a transferee FI (e.g., 306, 307), such as requests to transfer from consumer accounts 308-316 to merchant accounts 322-324, 326-328, the fund transfer system can direct the transfers first through an intermediary consumer FI holding account 317-319, then to an intermediary clearing account 320, 321 which is selected based on one or more factors, and then to an intermediary merchant FI holding account 325. If either the transferor FI or the transferee FI is an “out of network” FI, funds can be transferred without passing through an intermediary holding account from an intermediary clearing account to the “out of network” FI.

The fund transfer system can determine which clearing FI and/or which clearing account to use as a function of factors such as FI operating hours or status, FI relationships, intermediary status at FI, FI reputation and capability, fund transfer amount, available buffer at a clearing account, transactional cost, transactional cost basis, total transfer time, and other relevant factors.

Transfer can depend on FI operating hours or status. For example, transfer to or from a clearing account at a clearing FI may not be available if services are down at a particular time at the clearing FI (e.g., due to observation of holidays, technical outage, system blackout, maintenance hours, etc.) during an anticipated transfer time. The system may thus initiate transfer to a different clearing FI. Transfer can depend on intermediary status at a FI. For example, a FI may charge different costs and/or offer different delivery (e.g., transfer) times for clients with different status. In some instances, a FI may waive, reduce, or otherwise discount transfer or transaction costs for loyal or frequent clients, very important clients, clients having an amount of funds over a predetermined threshold (e.g., over $1,000, over $5,000, over $10,000, over $100,000, over $200,000, over $300,00, over $400,000, over $500,000, over $1,000,000, etc.) in one or more accounts at the FI, or other clients that have achieved special status. If the intermediary has achieved a special status or a special relationship (e.g., business terms) with a FI, the transfer cost can be waived, reduced, or otherwise discounted and make selection of the FI more favorable.

Transfer can depend on relationships between different FIs. For example, different FIs may have different preferred clearing FIs. In some instances, a plurality of FIs may be part of a same consortium, wherein in a clearing FI is selected from the consortium. In some instances, a clearing FI may provide or offer different (e.g., better, more timely, lower cost, etc.) services to certain FIs that have a special (e.g., business, municipal, etc.) relationship to the clearing FI.

Transfer can depend on the reputation of the FI. For example, a FI with higher reputation (e.g., with little or no record of complaints) or having certain guarantees (e.g., account balance protection policies) can be more favorable for selection than an FI with lower reputation or having no or little guarantees in the event of bankruptcy or occurrence of other unpredictable events. Customer service reputation of FI can also be a factor. Transfer can also depend on the capabilities of an FI to process a transfer. For example, a FI may or may not be able to facilitate certain international transfers to specific countries. A FI may or may not be able to process transfers in certain currencies. In some instances, a FI may not be able to facilitate certain international transfers and/or transfers in certain currencies effectively. A FI can be selected for its capabilities to facilitate a certain type of transfer.

Transfer can depend on fund transfer amount and available buffer funds at a clearing account. For example, if the transfer amount is low, a FI assessing costs at per amount basis can be more favorable. If the transfer amount is high, a FI assessing costs at per amount basis can be unfavorable. For example, if the fund transfer amount is high, and the system is likely to initiate a transfer simultaneously to and from a clearing account, the clearing account selected must have sufficient funds to at least cover the fund transfer amount.

Transfer can depend on transaction cost and transaction cost basis. For example, some FIs may assess transaction cost on a per transaction basis, per client basis, per amount basis. Clearing FIs and/or clearing accounts can be selected based on anticipated total transaction cost for transfer to and from the clearing FIs and/or clearing accounts.

Transfer can depend on total transfer time. For example, some FIs may offer different transfer or delivery time options. Accelerated delivery time options may incur extra costs. Such extra costs can also be considered by the fund transfer system as a factor. Clearing FIs and/or clearing accounts can be selected based on anticipated total transfer time to and from the clearing FIs and/or clearing accounts.

Transfer can depend on transferor and/or transferee requests. For example, a transferor and/or transferee may make hard requests as to total transaction costs and/or total transfer time, which the system may accommodate when selecting the clearing FIs and/or clearing accounts. In some instances, the fund transfer system may select clearing FIs and/or clearing accounts to optimize total transaction costs (e.g., preferably low), total transfer time (e.g., preferably low), and security and reliability (e.g., preferably high). The systems and methods described herein may implement one or more algorithms to make such determinations and/or perform such optimizations.

While FIG. 3 shows exemplary fund transfer paths, the fund transfer paths are not limited as such. In some instances, a transfer path can include any number of intermediary clearing accounts at any number of clearing FIs, wherein the funds pass through sequentially or selectively. In some instances, a transfer path can include any number of intermediary holding accounts, wherein the funds pass through sequentially or selectively. Such intermediary clearing accounts and/or holding accounts may be managed or owned by the same or different intermediaries. In some instances, for example, the system may achieve a fund transfer path of x amount of fund from a consumer account 308 to a merchant account 326 by transferring x amount of fund to the intermediary holding account 317, transferring x amount of fund from the intermediary holding account 317 to the clearing account 320, but transferring x amount of fund to the intermediary holding account 325 from a different clearing account 321, and transferring x amount of fund from the intermediary holding account 325 to the merchant account 326. Thus, the transfer path may not necessarily be connected fluidly via common accounts (e.g., holding accounts, clearing accounts, etc.).

While FIG. 3 illustrates transfers between a consumer and a merchant, the parties are not limited as such. The descriptions herein can apply to a transfer between any transferor (e.g., consumer, sender, payer, etc.) and any transferee (e.g., merchant, recipient, payee, etc.).). For example, the transfer can be any type of transfer described elsewhere herein (e.g., external funds transfer, person-to-person (P2P) transfer, business-to-business (B2B) transfer, online banking payment, government payment or disbursement, mortgage or bill payment, direct deposit, etc.).

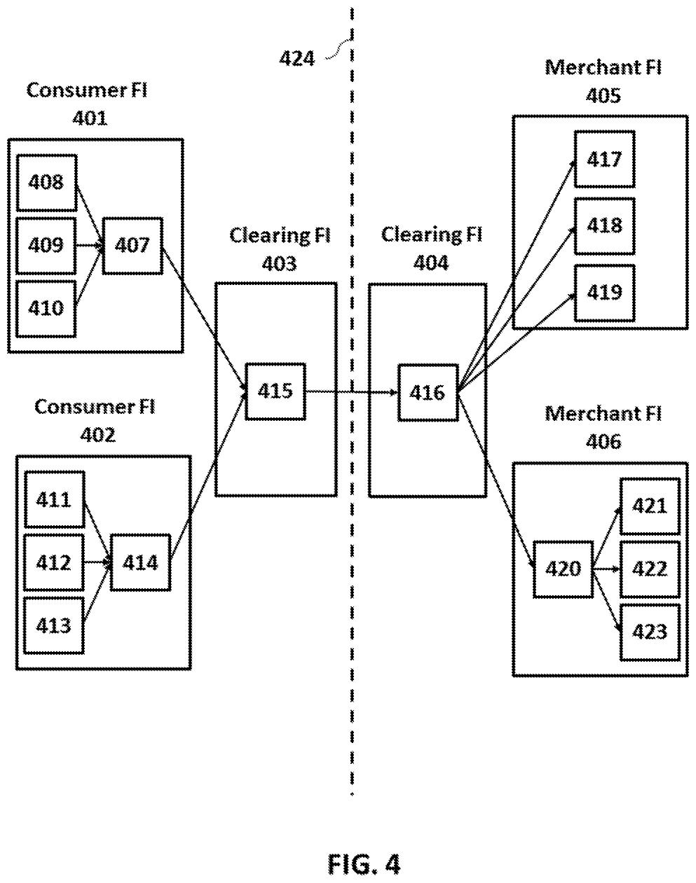

FIG. 4 shows a schematic transfer flow with multiple sequential clearing financial institutions facilitating international remittance.

One or more consumers may be accountholders at a consumer FI (e.g., 401 and 402) in a first sovereign state (e.g., country), and one or more merchants may be accountholders at a merchant FI (e.g., 405, 406) in a second sovereign state. For example, the first and second sovereign states can be divided by one or more state boundaries 424. Funds may be transferred from a consumer account (e.g., one of consumer accounts 408-413) to a merchant account (e.g., one of merchant accounts 417-419, 421-423) in a different sovereign state, such as by passing through an intermediary customer FI holding account (e.g., one of 407, 414), then through a first intermediary clearing account 415 at a first clearing FI 403 at a first sovereign state, then through a second intermediary clearing account 416 at a second clearing FI 404 at a second sovereign state, and then through an intermediary merchant FI holding account 420. The one or more consumer FIs, one or more clearing FIs, and one or more merchant FIs may each be the same FI or different FIs, or some FIs may be the same FI and other FIs may be different FIs. In some instances, the funds may be transferred directly from a consumer account to a merchant account without passing through one or more intermediary clearing account and/or without passing through one or more intermediary holding accounts.

A transfer can be initiated by the consumer, such as by submitting a request to ‘push’ funds to a merchant, such as from a customer account 408 to a merchant account 421. Alternatively, a transfer can be initiated by the merchant, such as by submitting a request to ‘pull’ funds (e.g., automatic bill payment, etc.) from a consumer. Such requests, commands, and/or instructions can be made electronically and/or online. Both the customer FI 401 to which the customer account 408 belongs and the merchant FI 406 to which the merchant account 421 belongs can be “in-network” FIs (e.g., for which an intermediary has an intermediary holding account).

Upon initiation of the transfer, the fund transfer system (e.g., system 100 in FIG. 1) can first initiate a transfer from the consumer account 408 to an intermediary customer FI holding account 407. The customer account and the intermediary customer FI holding account can both be at the same customer FI 401. An “on us” transfer may be completed between the consumer account and the intermediary customer FI holding account. Such “on us” transfers may incur relatively little or no cost and be completed in relatively less time.

The fund transfer system can then initiate a transfer from the intermediary consumer FI holding account 417 to a first intermediary clearing account 415 at a first clearing FI 403 which is located in the same country as the consumer FI 401. An ACH process may be used for this transfer. Alternatively, an “on us” transfer may be completed, for example, if the consumer FI 401 and the first clearing FI 403 are the same FI.

The fund transfer system can then initiate a transfer from the first intermediary clearing account 415 to a second intermediary clearing account 416 at a second clearing FI 404 which is located in the same country as the merchant FI 406. The first clearing FI 403 and the second clearing FI 404 can be located in different countries across state boundary 424. An ACH process or international interbanking network, such as SWIFT, Fedwire, or other networks can be used for this transfer. Such transfers over international boundaries can incur costs and a time delay (e.g., at least one business day, two business days, three business days, four business days, five business days, six business days, seven business days, or longer, etc.).

The fund transfer system can then initiate a transfer from the second intermediary clearing account 416 to an intermediary merchant FI holding account 420. An ACH process may be used. Alternatively, an “on us” transfer may be completed, for example, if the second clearing FI 404 and the merchant FI 406 are the same FI. The fund transfer system can then initiate a transfer from the intermediary merchant FI holding account 420 to the merchant account 421. An “on us” transfer may be completed between the intermediary merchant FI holding account and the merchant account. Such “on us” transfers may incur relatively little or no cost and be completed in relatively less time.

Similarly, upon request for other transfers from accounts at a transferor FI (e.g., 401, 402) to a transferee FI (e.g., 405, 406) across a state boundary 424, such as requests to transfer from consumer accounts 408-413 to merchant accounts 417-419, 421-423, the fund transfer system can direct the transfers first through an intermediary consumer FI holding account 407, 414, then to a first intermediary clearing account 415 in a first clearing FI 403 which is located in the same country as the transferor FI, then to a second intermediary clearing account 416 in a second clearing FI 404 which is located in the same country as the transferee FI, then to an intermediary merchant FI holding account 420. If either the transferor FI or the transferee FI is an “out of network” FI, funds can be transferred without passing through an intermediary holding account from an intermediary clearing account to the “out of network” FI.

Funds transferred from intermediary holding accounts in a transferor country can be aggregated and accumulated in an intermediary clearing account in a clearing FI in the transferor country. Beneficially, such aggregated funds can be transferred across state boundaries (e.g., boundary 424) in one transfer to an intermediary clearing account in a clearing FI in the transferee country. This may significantly reduce overall international transfer costs, such as where international interbanking transfer costs are incurred on a per transaction or per client basis.

Furthermore, the intermediary clearing accounts at each clearing FI can aggregate and accumulate buffer funds as different funds at different points in time pass through the intermediary clearing accounts. When there are sufficient buffer funds available in the intermediary clearing accounts, upon initiation of the transfer by the consumer, the fund transfer system may initiate transfers between (i) the intermediary consumer FI holding account and the first intermediary clearing account, (ii) the first intermediary clearing account and the second intermediary clearing account, and/or (ii) the second intermediary clearing account and the intermediary merchant FI holding account, substantially simultaneously or with relatively short time lapse (e.g., less than one business day). Significant time can be saved by deferring time delay of the international transfer through the simultaneous transfers.

Beneficially, international transfers facilitated by the systems and methods described herein do not require a sender to know extensive information from the recipient or the recipient's FI, such as an account number, routing number, and/or international banking number (e.g., SWIFT banking number). This can increase both security of the transfer and ease of use for all parties involved in the transfer.

While FIG. 4 shows exemplary fund transfer paths, the fund transfer paths are not limited as such. In some instances, an international fund transfer path (e.g., international remittance path) may involve a plurality of clearing banks and/or other international transfer mechanisms in addition to, or as part of, the link between the first intermediary clearing FI and the second intermediary clearing FI. While FIG. 4 illustrates transfers between a consumer and a merchant, the parties are not limited as such. The descriptions herein can apply to a transfer between any transferor (e.g., consumer, sender, payer, etc.) and any transferee (e.g., merchant, recipient, payee, etc.).). For example, the transfer can be any type of transfer described elsewhere herein (e.g., external funds transfer, person-to-person (P2P) transfer, business-to-business (B2B) transfer, online banking payment, government payment or disbursement, mortgage or bill payment, direct deposit, etc.).

In some aspects, the systems and methods described herein can facilitate payment of an invoice. For example, a customer may pay an invoice with aid of an optical sensor communicating with an electronic device. The electronic device can be a mobile device. The optical sensor can be a camera. The optical sensor can be integrated in the electronic device. The optical sensor can be external to the electronic device and communicatively coupled to the electronic device via wireless (e.g., Wi-Fi, Bluetooth, NFC, etc.) or wired (e.g., cable, etc.) connection. The optical sensor and/or one or more algorithms and/or software in the electronic device can be capable of reading an image. For example, the optical sensor may be able to read barcodes (e.g., quick response (QR) codes). For example, the optical sensor may be able to read text, such as via one or more optical character recognition (OCR) algorithms. The electronic device can comprise an electronic display. The electronic display can be integrated in the electronic device. The electronic display can be external to the electronic device and communicatively coupled to the electronic device via wireless (e.g., Wi-Fi, Bluetooth, NFC, etc.) or wired (e.g., VGA, HDMI, etc.) connection. The electronic display can be capable of presenting a user interface, such as a graphical user interface (GUI). The electronic display can be capable of presenting one or more invoices or information or data thereof to a user.

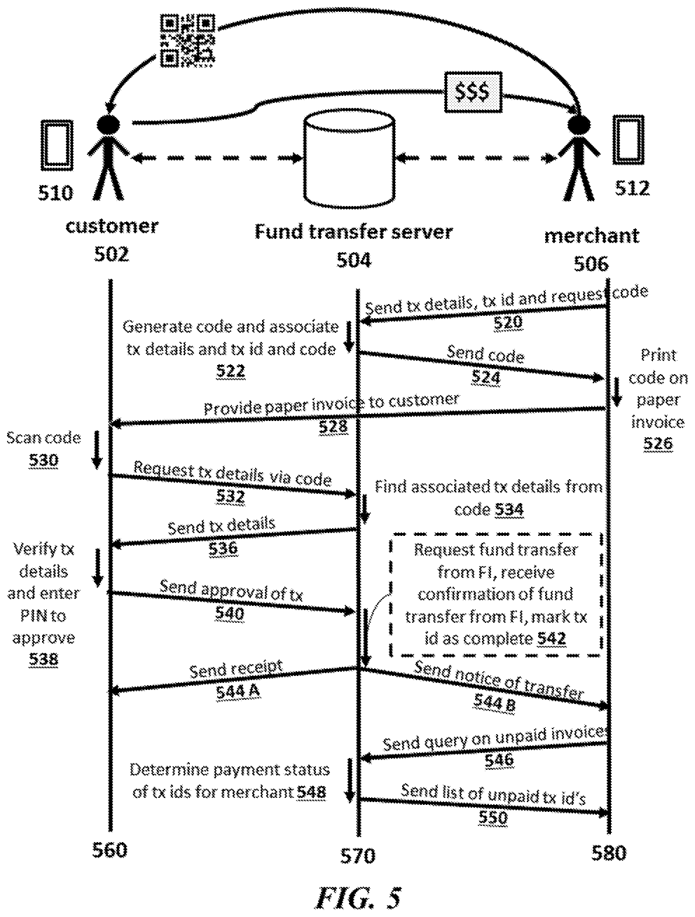

FIG. 5 shows a process flow for facilitating payment of a paper invoice using QR codes. In FIG. 5, the process(es) carried out by or involving a customer 502 are represented by a contact with a vertical line 560, the process(es) carried out by or involving a fund transfer server 504 are represented by a contact with a vertical line 570, and the process(es) carried out by or involving an intended recipient 506 are represented by a contact with a vertical line 580.

A customer 502 can process a payment to a merchant 506 with aid of a fund transfer server 504. The merchant may send an invoice to the customer with aid of the fund transfer server. The customer may process the payment and/or communicate with the server with aid of a first user device 510, and the merchant may send the invoice and/or communicate with the server with aid of a second user device 512. The user devices can be the user device 101, 102, 103, and 104 of FIG. 1.

When the customer 502 has unpaid dues to the merchant 506, for example, for purchase of goods or services form the merchant, the merchant can decide to send the customer an invoice. The invoice can be a paper invoice that is physically delivered or tendered to the customer. The invoice can be an electronic invoice that is electronically delivered, such as over a computer network. The invoice delivered to the customer can contain a QR code or other visual graphical indicia encoding information related to the invoice.

The visual graphical indicia can be a visual graphical barcode of any format, such as a bar code, text, a picture, a sequence thereof, or the like that can be captured and/or displayed on a device. The visual graphical barcode may be a two-dimensional barcode, such as PDF417, Aztec, MaxiCode, and QR code, etc. The visual graphical barcode may be a one-dimensional barcode, such as Interleaved 2/5, Industrial 2/5, Code 39, Code 39 Extended, Codabar, Code 11, Code 128, Code 128 Extended, EAN/UCC 128, UCC/EAN-128, UPC-E, UPC-A, EAN-8, EAN-13, Code 93, Code 93 Extended, DataBar Omnidirectional (RSS-14), DataBar Truncated (RSS-14 Truncated), DataBar Limited (RSS Limited), DataBar Stacked, DataBar Expanded, and DataBar Expanded Stacked, etc. The visual graphical barcode can encode various types of information in any type of suitable format, such as binary, alphanumeric, ASCII, and other formats, and the code can be based on any standards. The visual graphical barcode may have various storage capacities that can encode a certain amount of data, and variable physical size. In some embodiments, the visual graphical barcode may conform to known standards that can be read by standard barcode readers. In other embodiments, the visual graphical barcode may be proprietary such that it can be read only by an authenticated application provided by an authentication system running on a user device. In some instances, only the fund transfer system or proprietary application and/or software deployed by the fund transfer system can be capable of encrypting/decrypting the visual graphical barcode.

The visual graphical barcode can be a one-dimensional barcode, two-dimensional barcode or three-dimensional barcode. The visual graphical barcode can be, for example, one-dimensional barcode that includes linear patterns such as lines and spaces. The lines and spaces may be black-and-white. The lines and spaces can comprise more than one color. The color may be visible to human eyes. The color of the barcode may be distinguishable by special tools. For instance, the barcode may include print carbon lines which are detectable using an infrared scanner. The visual graphical barcode can be a two-dimensional barcode including various shapes. The visual graphical barcode may be static or dynamic. The visual graphical barcode may be changed or updated at a certain frequency. The frequency may vary widely in range, such as from 100 Hz to 0.001 Hz. Any description herein of a QR code can be applicable to any visual graphical barcode, and vice versa.

The merchant 506 can send 520 a QR code request to the fund transfer server 504. The QR code request can include information such as transaction details, a transaction identification number (ID) or any other information related to one or more transactions to be included in the invoice. For example, the QR code request can include at least all information that is printed on or included on the face of the invoice. Upon receipt of the QR code request from the merchant, the fund transfer server can generate 522 a QR code. The QR code can encode such transaction information provided by the merchant (e.g., transaction details, transaction ID, and/or any information related to one or more transactions to be included in the invoice, etc.). The fund transfer server can otherwise associate such transaction information to the QR code. The server can store such association information in memory, such as in a database. The server can send 524 the QR code to the merchant. Upon receipt of the QR code, the merchant can include 526 on the invoice to be sent to the customer. For example, the QR code can be printed on a paper invoice. In another example, the QR code can be attached or included in an electronic invoice. Alternatively or in addition, the fund transfer server can generate and send the merchant a code (e.g., alphanumeric code) or other data that the merchant can use to self-generate the QR code, and this code or other data can be associated with the transaction information in a database of the server.

The merchant 506 can then provide 528 the invoice with the QR code to the customer 502. In some instances, a paper invoice can be physically delivered or tended to the customer. In some instances, an electronic invoice can be electronically delivered to the customer, such as over a computer network. In some instances, an electronic invoice can be electronically delivered to the customer via the fund transfer server 504. In some instances, an electronic invoice can be displayed to the customer 502 over a display. For example, the electronic invoice can be displayed on a display provided by the merchant 506 or a display of the customer 502 (e.g., of a user device). The display may be, or be part of, a processing device (e.g., purchase processing device, cash register, etc.), a personal device (e.g., mobile phone, tablet, computer, monitor, etc.), or other device. Upon receipt of the invoice by the customer, the customer can use an optical sensor of the user device 510 to scan 530 the QR code on the invoice. In some instances, the user device 510 may execute scanning or optical recognition algorithms to identify, recognize, and/or scan a QR code from an electronic invoice accessed by the user device 510 without requiring a second device (a first device to display, and a second display to scan the display). Upon scanning of the QR code, the user device 510 can send a request 532 to the fund transfer server, requesting transaction information. The request can include one or more information (e.g., data, code, information uniquely encrypted in the QR code). Upon receipt of the request, the server can recall 534 the transaction information associated with the QR code, such as by searching the database of the server. The server can then send 536 the transaction information to the customer. The transaction information can be presented on an electronic display communicating with the user device 510. The transaction information can be presented on a GUI on the electronic display. In some instances, the transaction information can be presented in the form of an invoice (e.g., transaction information is located where it is conventionally located on an invoice, such as date on the top header, invoice sub-amounts at the bottom, invoice total below the invoice sub-amounts, and/other transaction details organized in table format, etc.). Upon presentation of the transaction information, the customer can verify 538 the transaction information for accuracy. If the customer determines that the transaction information is accurate, the customer can proceed with payment of the invoice such as by sending approval instructions to the server. If the customer determines that the transaction information is inaccurate, the customer can alert the server of such inaccuracy, such as by sending error alerts, disputes, or claims to the server. The server can communicate such error alerts, disputes, and/or claims from the customer to the merchant.

Alternatively, the customer (e.g., 502) can send a QR code request to the fund transfer server (e.g., 504). The QR code request can include information about the customer, such as the customer account information. In some instances, the QR code request can include information about the merchant (e.g., 506). In some instances, the QR code request can include information such as transaction details, a transaction identification number (ID) or any other information related to one or more transactions. For example, the QR code request can include at least all information that is printed on or included on the face of an invoice. Upon receipt of the QR code request from the customer, the fund transfer server can generate a QR code. The QR code can encode such customer account information provided by the customer. In some instances, the QR code can encode merchant information and/or transaction information provided by the customer (e.g., transaction details, transaction ID, and/or any information related to one or more transactions, etc.). The fund transfer server can otherwise associate such customer information, merchant information, and/or transaction information to the QR code. The server can store such association information in memory, such as in a database. The server can send the QR code to the customer. Alternatively or in addition, the fund transfer server can generate and send the customer a code (e.g., alphanumeric code) or other data that the customer can use to self-generate the QR code, and this code or other data can be associated with the transaction information in a database of the server.

Upon receipt of the QR code, the customer can present or otherwise display the QR code to the merchant. In some instances, the QR code can be printed on a paper and be physically delivered or tended to the merchant. In some instances, the QR code can be electronically delivered to the merchant, such as over a computer network. In some instances, the QR code can be electronically delivered to the merchant via the fund transfer server. In some instances, the QR code can be displayed to the merchant over a display. For example, the QR code can be displayed on a display provided by the customer (e.g., display of a user device) or a display of the merchant. The display may be, or be part of, a processing device (e.g., purchase processing device, cash register, etc.), a personal device (e.g., mobile phone, tablet, computer, monitor, etc.), or other device. Upon receipt of the QR code by the customer, the merchant can use an optical sensor of the a merchant device (e.g., purchase processing device, cash register, scanner, personal device, etc,) to scan the QR code. In some instances, the merchant device may execute scanning or optical recognition algorithms to identify, recognize, and/or scan the QR code without requiring a second device (a first device to display, and a second display to scan the display). Upon scanning of the QR code, the merchant device can send a request to the fund transfer server, requesting transaction information. The request can include one or more information (e.g., data, code, information uniquely encrypted in the QR code). Upon receipt of the request, the server can recall the customer and/or transaction information associated with the QR code, such as by searching the database of the server. In some instances, upon scanning of the QR code or simultaneously with scanning of the QR code, the merchant may transmit supplement information about the transaction (e.g., transaction details, merchant information, etc.) to the server. The server can then send the transaction information to the customer. The transaction information can be presented on an electronic display communicating with the customer user device (e.g., 510). The transaction information can be presented on a GUI on the electronic display. In some instances, the transaction information can be presented in the form of an invoice (e.g., transaction information is located where it is conventionally located on an invoice, such as date on the top header, invoice sub-amounts at the bottom, invoice total below the invoice sub-amounts, and/other transaction details organized in table format, etc.). Upon presentation of the transaction information, the customer can verify the transaction information for accuracy. If the customer determines that the transaction information is accurate, the customer can proceed with payment of the invoice such as by sending approval instructions to the server. If the customer determines that the transaction information is inaccurate, the customer can alert the server of such inaccuracy, such as by sending error alerts, disputes, or claims to the server. The server can communicate such error alerts, disputes, and/or claims from the customer to the merchant.

The customer 502 can be required to complete an authentication process before sending approval instructions to the server 504. For example, upon sending an intention to approve (e.g., selecting an “approve” or “confirm” option (user interactive component such as a button)) to the server, the server can send an authentication request to the customer. Alternatively, the customer can authenticate and approve simultaneously. Optionally, the customer can approve without separate authentication.

The authentication request may allow the individual to authenticate the individual's identity via biometric authentication. In some instances, the user device 510 and/or server 504 can individually or collectively comprise a biometric module for authentication. A biometric module may comprise hardware and software components for collecting, storing, processing, translating or analyzing biometric data. Biometric data may include any feature or output of an organism that can be measured and used to uniquely identify the organism. Biometric data may include, but are not be limited to, fingerprints, DNA, body temperature, face/hand/retina or ear features, behavioral characteristics such as typing rhythm, gait, gestures and voice. Hardware components in a biometric module may further comprise biometric readers, for example a fingerprint reader or retinal scanner, microprocessors, and RAM/ROM memory. Software components may comprise one or more software-based programs, including applications, protocols, or plugins, configured for collecting and/or processing biometric data from the hardware components of the biometric module. In some instances, collection and processing biometric data may comprise steps for analyzing the biometric data, creating a template (i.e. digital template) for biometric data, storing, matching, and verifying the biometric data (i.e. with an external database or previously stored information). In some embodiments, a biometric reader may also be coupled to a user device through wired or wireless connections. Wireless connections may include one or more types of Wi-Fi or peer-to-peer (P2P) networking protocols. In other embodiments, a biometric reader may be built into the web-enabled device. In some embodiments, the biometric module may be included, installed, or attached to the user device 510.

Alternatively or in addition, the authentication request may allow authentication via user credentials (e.g., PIN, password, passcode, etc.). For example, prior to authentication, a user (e., customer 502) may have provided the fund transfer server 504 with such user credentials, such as during or after registration with the server. Alternatively, or in addition, the authentication request may allow authentication via device (e.g., one-time password device, user device, etc.) authentication. Alternatively or in addition, the authentication request may allow authentication via third party service authentication (e.g., authentication via social networking system account, authentication via verified email account, etc.). If a recipient fails authentication, for example for a certain number of times (e.g., 3), the server may try contacting the customer 502 via a contact address (e.g., phone number, email address, etc.) to alert the customer 502 of possible fraud.

In some instances, the approval and/or authentication request may expire after a finite duration of time. An invoice may expire after a finite duration of time. For example, the request sent by the server 504 or invoice may expire after a certain period of time, such as in 10 seconds, 30 seconds, 1 minute, 5 minutes, 10 minutes, 30 minutes, 1 hour, 2 hours, 3 hours, 4 hours, 5 hours, 6 hours, 7 hours, 8 hours, 9 hours, 10 hours, 11 hours, 12 hours, 15 hours, 18 hours, 21 hours, 1 day (e.g., 24 hours), 2 days, 3 days, 4 days, 5 days, 6 days, 1 week (e.g., 7 days), 2 weeks, 3 weeks, 4 weeks, 1 month, 2 months, 3 months, 4 months, 5 months, 6 months, 9 months, 12 months, 1 year, 2 years, 3 years, or other duration of time. A QR code can have an expiration date. If a user does not provide approval and/or authentication within the certain period of time, the merchant 506 can be alerted, such as to encourage renewal of an invoice or remind payment of the invoice to the customer 502. In some instances, the QR code can include additional information, such as due date or due time of the payment, a number of times an invoice has been presented to the customer for payment, tax category of the payment, and/or other information. In some instances, upon expiration of an invoice, upon scanning of a QR code (e.g., after the due date or due time of the payment), the server can generate an error message informing the customer of the expiration. Alternatively, the request may not expire, and the customer may provide approval and/or authentication at any time.

With or after authentication, the customer 502 can send 540 approval instructions of the invoice to the fund transfer server 504. The approval instructions can instruct payment of the invoice to the merchant. In some instances, the approval instructions can include payment information required for payment of the invoice. In some instances, the payment information can be pre-stored in one or more secure (e.g., encrypted) databases of the server and the approval instructions can include approval from the customer for the server to use such payment instructions. Alternatively or in addition, the customer can manually input such payment information with or after authentication, and/or with approval.

Upon receipt of the approval instructions, the server 504 can request 542 a transfer of funds from a customer 502 account to a merchant 506 account. Specifics of the payment can be provided by the customer (e.g., in the approval instructions, payment preferences for the customer, etc.) and/or the merchant (e.g., in the invoice, payment preferences for the merchant, etc.). The transfer of funds can be requested to one or more financial institutions. In some instances, the transfer of funds can be achieved via systems and methods described previously herein (e.g., breaking up the transfer process, clearing accounts, holding accounts, multiple clearing accounts, multiple holding accounts, timing, optimizing transfer time and cost, etc.). After receiving confirmation of fund transfer from one or more FIs, the server can mark the particular transaction ID as completed and/or the invoice as paid. Such completion information can be stored in one or more databases of the fund transfer server. The one or more databases of the server can be searchable. The one or more databases can individually or collectively perform or implement systems and methods described herein. Upon confirmation of fund transfer, the server 504 can then send 544A an invoice receipt to the customer 502 and send 544B a notice of the fund transfer to the merchant 506. In some instances, the invoice receipt and the notice of the fund transfer can be sent simultaneously. In some instances, the invoice receipt can be sent before confirmation of successful fund transfer, but after approval instructions are sent by the customer. In some instances, the invoice receipt can be sent after a request for a fund transfer is made to one or more FIs by the fund transfer server. For example, if a fund transfer fails after the request, the server can update the customer with such error and update the server databases to mark the transaction ID as incomplete.

At any point in time during the process, the merchant 506 can request from the server 504 a query about the status of invoices for the merchant. Upon receiving such query, the server 504 can scan the one or more databases for transaction IDs associated with the merchant to determine 548 the payment status of invoices for the merchant. For example, statuses of the invoices can include, but are not limited to, paid, unpaid, expired, overdue, cancelled, refunded, or other statuses. The server can send 550 such data, such as a list of unpaid invoices (e.g., transaction IDs) and/or a list of paid invoices, to the merchant. The user device 512 of the merchant 506 can be capable of presenting such data to the merchant, such as on a graphical user interface on an electronic display communicatively coupled to the user device 512. Alternatively or in addition, the customer 502 can request from the server a query on the status of invoices for the customer. Alternatively or in addition, the server may automatically provide, without manual request, a list of paid invoices and/or unpaid invoices, or invoices with other statuses, to a customer and/or merchant. For example, such lists can be provided periodically (e.g., annually, monthly, quarterly, biannually, bimonthly, weekly, biweekly, etc.), such as a part of a report. For each invoice, such list and/or report generated by the server can include information such as, payor (e.g., customer), payee (e.g., merchant), invoice number (e.g., transaction ID), amount paid, due date, payment date, method of payment, and/or other information related to a given invoice and/or payment of the given invoice. A report and/or list (e.g., requested or automatically generated) provided by the server can be filtered, sorted, and/or searched, such as by invoice status, by customer, by merchant, by due date, by invoice amount, and/or by any other data on or relating to the invoice.

Accounting data, such as reports and/or lists generated by the server 504, or any previous invoices using the fund transfer server can be imported by a user (e.g., customer, merchant), such as for incorporation into existing reports, statements, tax software, and/or accounting sheets.

While FIG. 5 shows one fund transfer server 504, there may be one or more fund transfer servers, collectively or individually, implementing the functions of the fund transfer server 504 described herein. For example, a first fund transfer server can generate the QR code, a second fund transfer server can facilitate transfer of funds, and a third fund transfer server can facilitate accounting by providing reports or list of paid and/or unpaid invoices.

In some instances, a customer and/or merchant may discover exceptions or errors in one or more invoices before or after payment by the customer. The customer and/or merchant can generate and/or report such exceptions to the server 504. The server can send the exception report to a payee FI, request reversal of payments made in error, inform the payee of the reversal, and/or thereafter send confirmation of corrected or updated electronic receipt for the refund.

Beneficially, translating such transaction and/or invoice information into electronic storage can provide long term storage. Further, allowing access of such information via scanning a QR code can facilitate convenient payment and/or accounting of invoices. For example, even if a paper invoice provides all information required or desired for payment (e.g., to a customer, from a merchant), such paper invoice can be lost easily, damaged (e.g., fading ink, torn, ripped, wrinkled, crumpled, folded, etc.), and accounting errors can be made while translating or transferring one or more information on the invoice (e.g., amount paid, amount to be paid) to an accounting sheet (e.g., hard copy or electronic) or accounting device (e.g., calculator).

In some embodiments, the invoice may be provided from the merchant to the customer without a QR code. The customer can scan the invoice without the QR code with an optical sensor (e.g., camera) on a user device. The optical sensor can, in conjunction with one or more OCR algorithms, read and recognize text and/or numbers from the invoice. Based on such reading and recognition, the server can identify the information needed for processing payment and automatically present such information to the customer, such as on a graphical user interface, for verification. Operations 538-544 can follow thereafter. In some instances, to aid accuracy of the one or more OCR algorithms, the server can provide an invoice template to the merchant. Alternatively or in addition, a merchant can provide an invoice template to the server. The one or more OCR algorithms can then be tailored to accurately recognize certain information from the invoice template (e.g., coordinate location of information relative to boundaries of an invoice).

In some embodiments, QR codes can be pre-generated for goods or services (for sale).

Any and all communications between the customer 502, fund transfer server 504, and/or merchant 506 can be electronic (e.g., via electronic mail, via server user interface, etc.) or non-electronic (e.g., physically delivered, physically communicated). The customer and the merchant can be in the vicinity of each other (e.g., in same store, same restaurant, same gas station, etc.). The customer and merchant can be remote from each other.

In some embodiments, the user device of a customer or consumer can have geo-location capabilities, and be capable of determining a point of sale (e.g., for a merchant). For example, on one or more geolocation sensors can determine a point of sale and/or a specific merchant based on location. Beneficially, such geo-location detection can provide increased security. By using geolocation as a means of identifying merchants and payment points, payments processed can be scanned for fraud based on whether the customer user device facilitating the payment is in the vicinity of the merchant to which the customer is providing payment. Furthermore, using such geolocation sensors, a customer may be automatically presented with pre-generated QR codes for payment of goods or services nearby, and process payment without having to scan a QR code, which may be difficult in some environments (e.g., low lighting). For example, some embodiments of QR codes (e.g., printed out) can be vandalized and made unreadable. A merchant may also benefit from improved advertising. By knowing that a customer is in the vicinity of the merchant, targeted advertising can be sent to the customer even before a purchase is made. Based on a location, the customer can also be presented with coupons, rewards, and offers. The customer may also be informed of the existence of merchants in the vicinity that offer the services using the systems and methods disclosed herein. If a customer has an existing gift card, coupon, discount, rewards, or other offers with (or applicable to) the merchant, the customer can be informed of an opportunity use such offers.

In some instances, the user device of a merchant can also have geo-location capabilities, and be determining a point of sale. In some embodiments, a point of sale (e.g., for a merchant) can be determined by a beacon (e.g., Bluetooth beacon) of a user device of the merchant broadcasting the identity of the point of sale.

In some embodiments, the systems and methods described herein can be remotely accessed, such as via a web-based interface. For example, the transfer of funds, and/or details thereof, can be viewed, modified, and administered by a remote online website. Beneficially, such remote access can provide remote system administration, remote research of payments, and remote conflict resolution (e.g., disputes).

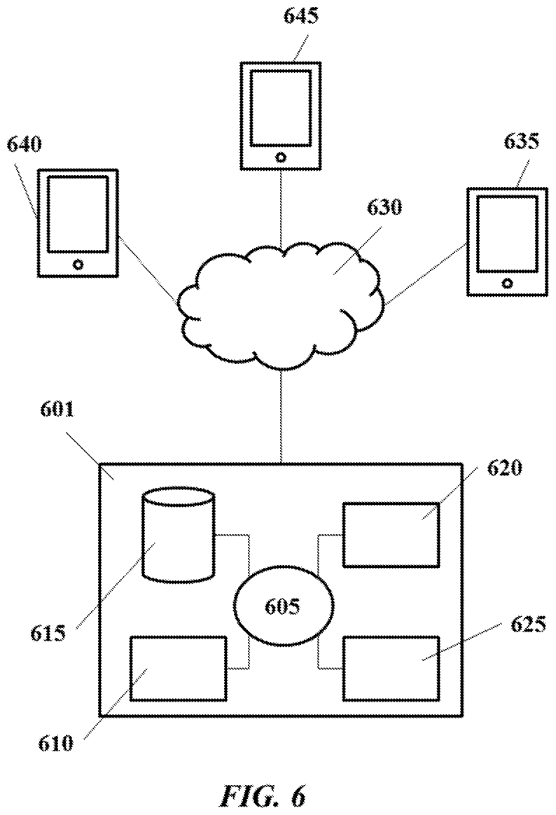

The present disclosure provides computer control systems that are programmed to implement systems and methods of the disclosure. FIG. 6 shows a computer system 601 that is programmed or otherwise configured to facilitate transfer of funds, payment processing, and/or invoice payment and accounting. The computer system 601 can regulate various aspects of (1) utilizing multiple clearing financial institutions (FIs), (2) utilizing multiple sequential clearing FIs for fund transfers between different countries, (3) utilizing push-only transfers, and/or (4) utilizing quick response (QR) codes to facilitate payment and accounting of invoices. In some instances, the fund transfer system 100 in FIG. 1 can comprise the computer system 601.

The computer system 601 includes a central processing unit (CPU, also “processor” and “computer processor” herein) 605, which can be a single core or multi core processor, or a plurality of processors for parallel processing. The computer system 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 can be a data storage unit (or data repository) for storing data. The computer system 601 can be operatively coupled to a computer network (“network”) 630 with the aid of the communication interface 620. The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630, in some cases with the aid of the computer system 601, can implement a peer-to-peer network, which may enable devices coupled to the computer system 601 to behave as a client or a server.

The CPU 605 can execute a sequence of machine-readable instructions, which can be embodied in a program or software. The instructions may be stored in a memory location, such as the memory 610. The instructions can be directed to the CPU 605, which can subsequently program or otherwise configure the CPU 605 to implement methods of the present disclosure. Examples of operations performed by the CPU 605 can include fetch, decode, execute, and writeback.

The CPU 605 can be part of a circuit, such as an integrated circuit. One or more other components of the system 601 can be included in the circuit. In some cases, the circuit is an application specific integrated circuit (ASIC).

The storage unit 615 can store files, such as drivers, libraries and saved programs. The storage unit 615 can store user data, e.g., user preferences and user programs. The computer system 601 in some cases can include one or more additional data storage units that are external to the computer system 601, such as located on a remote server that is in communication with the computer system 601 through an intranet or the Internet.

The computer system 601 can communicate with one or more remote computer systems through the network 630. For instance, the computer system 601 can communicate with a remote computer system of a user (e.g., user device having a user interface). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 601 via the network 630. For example, the computer system 601 can communicate with a first user device 635, a second user device 640, and a third user device 645.

Methods as described herein can be implemented by way of machine (e.g., computer processor) executable code stored on an electronic storage location of the computer system 601, such as, for example, on the memory 610 or electronic storage unit 615. The machine executable or machine readable code can be provided in the form of software. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 601 can include or be in communication with an electronic display that comprises a user interface (UI) for providing, for example, QR codes, transaction information, fund transfer information, and/or other details. Examples of UI's include, without limitation, a graphical user interface (GUI) and web-based user interface. The electronic display can be integrated or in a user device (e.g., 635, 640, 645). The electronic display can be external to a user device and in communication via wireless or wired connections to the user device.

Methods and systems of the present disclosure can be implemented by way of one or more algorithms. An algorithm can be implemented by way of software upon execution by the central processing unit 605. The algorithm can, for example, optimize a fund transfer path, such as through one or more intermediary clearing accounts, one or more intermediary holding accounts, and/or across state borders. The algorithm can generate unique QR codes or other graphical indicia, and encrypt or decrypt information in such QR codes. The algorithm can be capable of distinguishing paid and unpaid invoices, and generating a list of such. The algorithm can facilitate other embodiments of fund transfers described herein.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-57. (canceled)

58. A transfer system, comprising:
a communications interface in communication with a first electronic device of a first user and a second electronic device of a second user over a computer network; and
one or more computer processors operatively coupled to the communications interface, wherein the one or more computer processors are individually or collectively programmed to:
generate a graphical code encoding information about a transaction between the first user and the second user;
provide the graphical code to the first electronic device of the first user for presentation to the second user;
upon scanning of the graphical code by an optical sensor, provide the information about the transaction to the second electronic device of the second user;
upon receiving approval of the transaction from the second electronic device, aggregate entity data from each of a plurality of entities, wherein the data comprises geographical restrictions of each entity and temporal restrictions of each entity; and
determine, based on the entity data aggregated and the information about the transaction, an entity of the plurality of entities to process the transaction, to generate a transfer path for the transaction, wherein the transfer path for the transaction comprises, in order, a second user account of the second user, at least one intermediary account of the entity, and a first user account of the first user.

59. The transfer system of claim 58, wherein the graphical code is a QR code.

60. The transfer system of claim 58, wherein the graphical code is a UCC/EAN-128 code.

61. The transfer system of claim 58, wherein the one or more computer processors are individually or collectively programmed to detect a location of the transaction using one or more geo-location sensors in the first electronic device or the second electronic device.

62. The transfer system of claim 61, wherein the information about the transaction comprises the location of the transaction.

63. The transfer system of claim 58, wherein the information about the transaction comprises a transaction value.

64. The transfer system of claim 58, wherein the first user or the second user is a user of a social networking system.

65. The transfer system of claim 64, wherein the first user and the second user are users of the social networking system, and the communication interface is configured to send a notice of the transaction from the first electronic device to the second electronic device via the social networking system.

66. The transfer system of claim 58, wherein the communications interface is configured to communicate with the first electronic device or the second electronic device via a web-based interface.

67. The transfer system of claim 66, wherein the one or more computer processors are individually or collectively programmed to display the information about the transaction, or modify or administer the transaction via the web-based interface.

68. The transfer system of claim 66, wherein the web-based interface is a website hosted by a server remote from the first electronic device and the second electronic device.

69. The transfer system of claim 58, wherein the one or more computer processors are configured to provide the information about the transaction to the second electronic device of the second user upon scanning of the graphical code by the second electronic device, wherein the second electronic device comprises the optical sensor.

70. The transfer system of claim 58, wherein the entity of the plurality of entities is determined based at least on a total transfer time for the transaction from the second user account to the first user account, wherein the total transfer time is determined based on the entity data aggregated.

71. The transfer system of claim 70, wherein the entity provides a plurality of different time options, and wherein the total transfer time is determined based on a delivery time option selected from the plurality of different time options.

72. The transfer system of claim 58, wherein the one or more computer processors are individually or collectively programmed to determine the entity based at least in part on user preference of the entity.

73. The transfer system of claim 58, wherein the transfer path comprises at least two intermediary accounts, wherein the at least two intermediary accounts comprises the at least one intermediary account of the entity.

74. The transfer system of claim 58, wherein the at least two intermediary accounts are associated with at least two entities of the plurality of entities.

75. The transfer system of claim 58, wherein the first user account of the first user is located at a first entity located in a first sovereign state and the second user account of the second user is located at a second entity located in a second sovereign state, and wherein the transfer path comprises, in order, at least a first clearing account at a third entity located in the second sovereign state and a second clearing account at a fourth entity located in the first sovereign state.

76. The transfer system of claim 58, wherein the one or more computer processors are individually or collectively programmed to request initiation of the transaction according to the transfer path from the first user account.

77. The transfer system of claim 58, wherein the one or more computer processors are individually or collectively programmed to request initiation of the transaction according to the transfer path from the second user account.
